(19) United States
(12) Patent Application Publication
(10) Pub. No.: US 2026/0080659 A1
(43) Pub. Date: Mar. 19, 2026

(54) SCENE GRAPHS FOR VIDEO SCENE UNDERSTANDING AND INFORMATION RETRIEVAL

(71) Applicant: NVIDIA Corporation, Santa Clara, CA (US)

(72) Inventors: Vignesh Srinivasakumar, Fremont, CA (US); Prashant Gaikwad, San Jose, CA (US); Shivam Lakhotia, Sunnyvale, CA (US); Ashwani Agarwal, San Jose, CA (US)

(21) Appl. No.: 18/884,456

(22) Filed: Sep. 13, 2024

(51) Int. Cl. G06V 10/426; G06V 40/20

(52) U.S. Cl. CPC G06V 10/426; G06V 40/20

(57) ABSTRACT

In various examples, generating and using interaction graphs for video information retrieval systems and applications is described herein. Systems and methods are disclosed that process videos generated using one or more image sensors in order to generate a graph that represents at least interactions between entities depicted by the videos. For instance, nodes of the graph may be associated with the entities—such as people and/or other objects—as well as attributes associated with the entities. Additionally, edges of the graph may be associated with interactions between the entities, times that the interactions occurred, and/or indications of which videos depict the interactions. Systems and methods are then further disclosed that use the graph to perform information retrieval associated with the videos. For instance, the graph may be used to identify relevant information associated with a query, where the information may then be used to generate a response.

### BACKGROUND

Systems use cameras for a variety of applications, such as to monitor warehouses, factories and/or retail environments to optimize paths and/or product or object placement, determine information about surrounding environments for autonomous driving, or provide security for personal residents and/or businesses. In some circumstances, it may be important to determine information about videos captured by such cameras. For example, if a camera captured an event-such as a worker at a warehouse causing an accident while driving a forklift-then it may be important to determine information about the event and/or retrieve portions of videos that depict the event. However, it may be difficult to precisely identify the important information and/or portions of the videos. For example, if the warehouse in the example above includes multiple cameras capturing the interior of the warehouse, where each camera is continuously generating videos, it may be difficult to identify which videos depict the event.

As such, techniques have been developed for retrieving relevant information about videos based on user requests. For instance, a system may process videos to generate descriptions that include information about each frame. For example, if a frame represents a worker driving a forklift, then a description for the frame may indicate an identifier for the worker driving the forklift, a time that the worker is driving the forklift, and a location within the warehouse at which the forklift was being driven. When receiving a query for retrieving information associated with an event, the system may then compare the query (e.g., an embedding associated with the query) to the generated descriptions (e.g., embeddings associated with the descriptions) in order to identify which of the descriptions include the information that is relevant to the event. Additionally, the system may then provide these identified descriptions back to a user that provided the query.

However, multiple problems may occur with regard to these techniques that merely generate descriptions for frames for later retrieval. For instance, since these systems generate descriptions for individual frames of the videos, the descriptions may lack context and/or causal relationships between frames, which may reduce the quality of the information that is retrieved. For example, if multiple videos capture an event that occurs over a period of time and/or different periods of time, the systems do not relate the frames that depict the event such that the most relevant information may not be retrieved for a query. Additionally, since multiple cameras may be used to generate videos, these systems may require large amounts of computing resources to generate and/or store these descriptions for the videos. For example, storing data (e.g., embeddings) for each frame, which may include tens of thousands of frames for a single video over a period of time, may require large amounts of memory. Furthermore, and for similar reasons, these systems may include large latencies when searching through the stored data in order to identify the information that may be relevant to a query.

### SUMMARY

Embodiments of the present disclosure relate to generating and using interaction graphs for video information retrieval systems and applications. Systems and methods are disclosed that process videos generated using one or more image sensors in order to generate a graph that includes representations of interactions between entities depicted by the videos. For instance, nodes of the graph may be associated with the entities—such as people and/or other objects—as well as attributes associated with the entities. Additionally, edges of the graph may be associated with interactions between the entities, times that the interactions occurred, and/or indications of which videos depict the interactions. Systems and methods are then further disclosed that use the graph to perform information retrieval associated with the videos. For instance, when receiving a query, information relevant to the query may be determined using the graph and/or one or more other sources (e.g., a database that stores descriptions of frames). One or more language models may then process input data associated with this information to generate a response to the query.

In contrast to conventional systems, the systems of the present disclosure, in some embodiments, may generate and then use the interaction graph that represents the context and/or casual relationships between the frames of the videos (e.g., the interactions). As such, the systems of the present disclosure may identify information that is more relevant to queries, such as by identifying information across multiple frames that are related based on entities and/or interactions. Additionally, in contrast to the conventional systems, in some embodiments, the graph may allow for the systems of the present disclosure to more efficiently answer time-related and/or entity-related queries. For instance, one or more portions of the graph may be filtered based on text from a query such that the relevant portions of the graph are processed when performing information retrieval. Furthermore, and as described in more detail herein, descriptions associated with the videos and/or frames of the videos may be filtered using the identified information from the graph, which may further reduce the latency when performing information retrieval.

### BRIEF DESCRIPTION OF THE DRAWINGS

The present systems and methods for generating and using interaction graphs for video information retrieval systems and applications are described in detail below with reference to the attached drawing figures, wherein:

FIG. 1A illustrates an example of a process for generating interaction graphs associated with videos, in accordance with some embodiments of the present disclosure;

FIG. 1B illustrates an example of a process for performing information retrieval using interaction graphs, in accordance with some embodiments of the present disclosure;

FIG. 2 illustrates an example of a video that represents interactions between entities, in accordance with some embodiments of the present disclosure;

FIG. 3 illustrates an example of generating computer-vision information associated with a frame of a video, in accordance with some embodiments of the present disclosure;

FIG. 4 illustrates an example of generating a description associated with a frame of a video, in accordance with some embodiments of the present disclosure;

FIG. 5 illustrates an example of generating a summary associated with a description and/or a frame of a video, in accordance with some embodiments of the present disclosure;

FIG. 6 illustrates an example of generating an interaction graph associated with a video, in accordance with some embodiments of the present disclosure;

FIG. 7 illustrates an example of generating a query associated with performing information retrieval, in accordance with some embodiments of the present disclosure;

FIG. 8 illustrates an example of generating a summary associated with a query, where the summary is used to perform information retrieval, in accordance with some embodiments of the present disclosure;

FIG. 9 illustrates an example of using a summary to retrieve information from a graph, in accordance with some embodiments of the present disclosure;

FIG. 10 illustrates an example of using retrieved information to generate a response associated with a query, in accordance with some embodiments of the present disclosure;

FIG. 11 illustrates an example of one or more systems that may be configured to perform one or more of the processes described herein, in accordance with some embodiments of the present disclosure;

FIG. 12 illustrates a flow diagram showing a method for generating an interaction graph associated with one or more videos, in accordance with some embodiments of the present disclosure;

FIG. 13 illustrates a flow diagram showing a method for performing information retrieval using an interaction graph, in accordance with some embodiments of the present disclosure;

FIG. 14A is a block diagram of an example generative language model system suitable for use in implementing at least some embodiments of the present disclosure;

FIG. 14B is a block diagram of an example generative language model that includes a transformer encoder-decoder suitable for use in implementing at least some embodiments of the present disclosure;

FIG. 14C is a block diagram of an example generative language model that includes a decoder-only transformer architecture suitable for use in implementing at least some embodiments of the present disclosure;

FIG. 15 is a block diagram of an example computing device suitable for use in implementing at least some embodiments of the present disclosure; and

FIG. 16 is a block diagram of an example data center suitable for use in implementing at least some embodiments of the present disclosure.

### DETAILED DESCRIPTION

Systems and methods are disclosed related to generating and using interaction graphs for video information retrieval systems and applications. For instance, a system(s) may receive, retrieve, obtain, access, and/or store video data generated using one or more image sensors (e.g., one or more cameras). As described herein, the video data may represent one or more videos that depict at least entities and/or interactions between the entities. In some examples, an entity may include, but is not limited to, a person, a vehicle, a machine, an animal, equipment, a shelf, a box, and/or any other type of object. Additionally, an interaction may include, but is not limited to, approaching an entity, walking away from an entity, talking to an entity, instructing an entity, pushing an entity, placing an entity, lifting an entity, carrying an entity, driving an entity, causing a collision with an entity, and/or any other type of interaction that may occur between two or more entities.

The system(s) may then process the video data—such as by using one or more computer-vision (CV) models, algorithms, and/or any other type of processing component—to determine CV information associated with the frames of the video(s). As described herein, the CV information may include, but is not limited to, identifiers of the entities, locations of the entities within the frames, bounding shapes (e.g., bounding boxes) representing portions of the frames that depict the entities, attributes associated with the entities, actions being performed by the entities, and/or any other information. The system(s) may also process the video data and/or the CV information—such as by using one or more language models (e.g., one or more vision-language models) and/or any other type of processing component—to generate descriptions representing information associated with the frames. For instance, in some examples, a description associated with a frame may include identifiers for the entities depicted by the frame, a location that the frame depicts, a time that the frame was generated, one or more interactions between the entities as depicted by the frame, the attributes associated with the entities, and/or any other information associated with the frame.

In some examples, the system(s) generates a respective description for each frame. Additionally, or alternatively, in some examples, the system(s) generates a respective description for groups of frames. In any of these examples, the system(s) then stores the CV information and/or the descriptions in one or more databases for later retrieval. For example, the system(s) uses one or more encoders to generate embeddings associated with the CV information and/or the descriptions. The system(s) then stores the embeddings in one or more vector databases.

The system(s) may then process the descriptions—such as by using one or more language models (e.g., one or more text2cypher language models) and/or any other type of processing component—to generate text (referred to, in some examples, as “summaries”) associated with the descriptions. As described herein, a summary associated with a description may indicate at least one or more entities described in the description, one or more interactions between the one or more entities as described in the description, and/or a timestamp associated with the interaction(s). For example, if a description associated with a frame describes that a first entity provided instructions to a second entity that is located in a warehouse and at 5:00, then the summary may include “Entity 1→instruction (5:00)→Entity 2.” For instance, in some examples, the summary may be associated with a specific type of language, such as a Cypher Query Language (and/or any other type of query language).

The system(s) may then use the summaries to generate a graph associated with the video(s), which may also be referred to as an “interaction graph.” For instance, the system(s) may generate the graph such that nodes of the graph are associated with the entities from the video(s) and/or additional information associated with the entities, such as attributes (e.g., the CV information) corresponding to the entities. The system(s) may further generate the graph such that edges of the graph are associated with interactions between the entities and/or additional information associated with the interactions, such as timestamps indicating when the interactions occurred. Additionally, the system(s) may continue to update the graph as the image sensor(s) continues generating the video(s) and/or new descriptions for the video(s) are received.

For example, if a first summary associated with a first frame indicates a first person, then the system(s) would generate the graph to include a first node associated with the first person. Next, if a second summary associated with a second frame indicates a second person instructing the first person, then the system(s) may update the graph to include a second node associated with the second person and an edge between the first and second nodes that is associated with the instructing interaction. Next, if a third summary associated with a third frame indicates the first person is performing an action associated with the instructions, such as driving a forklift, then the system(s) may update the graph to include a third node associated with the forklift and a second edge between the first and third nodes that indicates the driving interaction. This process may then continue to repeat as the system(s) continues to generate additional summaries associated with the video(s).

As described herein, the system(s) may then use the graph to perform information retrieval, such as when receiving queries from users associated with the video(s). For instance, the system(s) may receive a query for retrieving information relevant to an event that occurred and which is depicted by the video(s). In some examples, the system(s) may then process the query—such as by using one or more automatic speech recognition (ASR) models, one or more natural language understanding (NLU) models, one or more language models, and/or any other type of processing component—to generate text associated with the query. For example, the text may represent a transcript of user speech associated with the query. Additionally, in some examples, the system(s) may process the text—such as by using the language model(s) (e.g., the text2cypher model(s))—to generate a summary associated with the query. For example, the summary may indicate one or more entities, one or more interactions, one or more timestamps, one or more actions to perform, and/or any other information associated with the query.

The system(s) may then use the query summary to search through the graph and identify information that is relevant to the query. For example, if the query is requesting a name of a person that performed a specific interaction, then the retrieved information may indicate at least an identifier associated with the person. In some examples, such as to improve the search, the system(s) may filter at least a portion of the graph using one or more terms from the query summary. For a first example, if the query summary indicates a time period, then the system(s) may filter the graph in order to search through a portion of the graph that is associated with the time period (e.g., interactions that occurred within a threshold time interval around the time period). For a second example, if the query summary indicates an identifier of an entity, then the system(s) may filter the graph in order to search through an initial node that is associated with the entity and/or one or more additional nodes that are connected to the initial node. While these are just a few examples of using limiting terms to filter a portion of the graph, in other examples, additional and/or alternative terms may be used to filter the graph during information retrieval.

In some examples, system(s) may then use the retrieved information from the graph to generate a response to the query. For instance, the system(s) may process input data associated with the retrieved information—such as by using one or more language models and/or any other type of processing component—to generate the response. However, in other examples, the system(s) may process additional data when generating the response, such as text associated with the query, a prompt representing instructions to generate the response, and/or one or more descriptions associated with the video(s).

For example, the system(s) may process the text associated with the query—such as by using one or more encoders and/or any other type of processing component—to generate one or more embeddings corresponding to the query. The system(s) may then use the query embedding(s) to search through the vector database(s) in order to identify one or more descriptions that are related to the query. In some examples, to improve this search (e.g., reduce the latency associated with the search), the system(s) may use the retrieved information from the graph to filter the descriptions. For instance, the system(s) may use one or more timestamps from the retrieved information to filter the descriptions, such that descriptions for frames that were generated within a threshold time interval to the timestamp(s) are searched. In this example, the system(s) may then further process input data representing the retrieved description(s) when generating the response.

In some examples, the system(s) may further provide additional information related to the query. For instance, the system(s) may retrieve one or more portions of the video(s) that are associated with the query—such as depicting the event indicated by the query—along with the response. In some examples, the system(s) may use the retrieved information from the graph to identify the portion(s) of the video(s). For example, the system(s) may use the timestamp(s) associated with the retrieved information to identify the portion(s) of the video(s) that was generated proximate (e.g., within a threshold time interval) to when the event occurred. As such, by performing one or more of the processes described herein, the system(s) may use the graph to improve the information retrieval process, such as by identifying relevant information from the graph, identifying relevant descriptions, identifying relevant portions of videos, and/or generating more relevant responses.

As described herein, the processes may be used with regard to various technologies. For a first example, if machines (e.g., autonomous and/or semi-autonomous vehicles) include cameras for navigating, the system(s) described herein may process the videos in order to generate interaction graphs and/or vector databases associated with the videos. The system(s) may then use the interaction graphs and/or the vector databases to perform information retrieval for events related to autonomous driving, such as events that are important for analyzing how the machines navigated. For a second example, if a warehouse includes cameras that generate videos representing the interior of the warehouse, then the system(s) described herein may again process the videos to generate an interaction graph and/or a vector database associated with the videos. Additionally, the system(s) may use the interaction graph and/or the vector database to perform information retrieval for events related to the warehouse, such as specific interactions that occurred within the warehouse.

In some examples, one or more of the models described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In some embodiments, the model(s) described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., user queries, prompts, etc.), and enterprise management software to provide health checks, identity, and other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

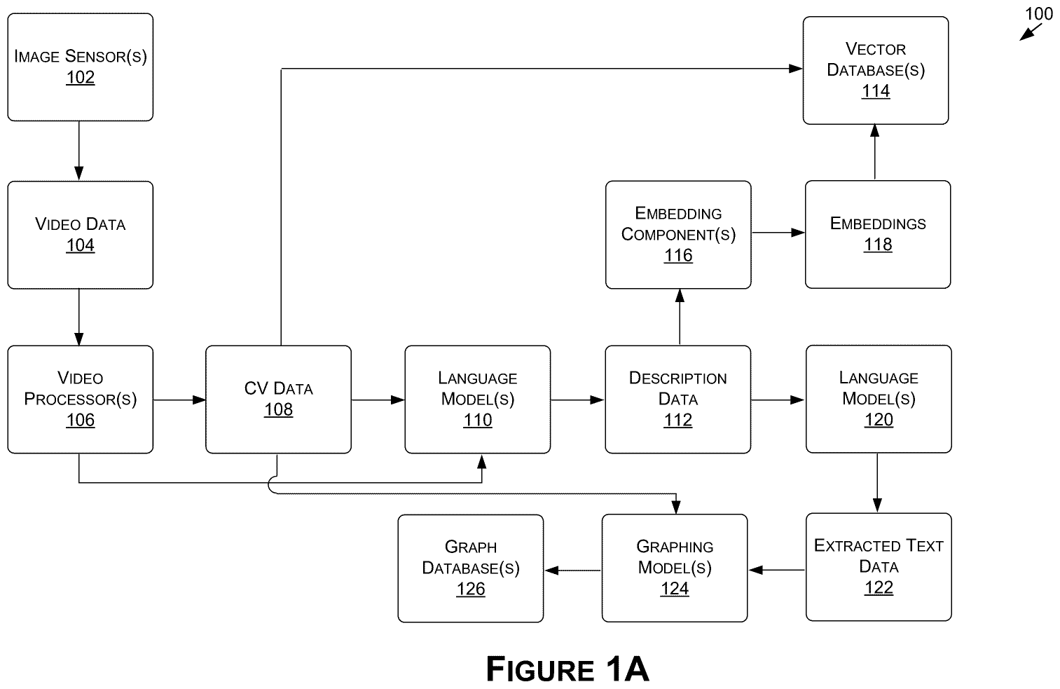

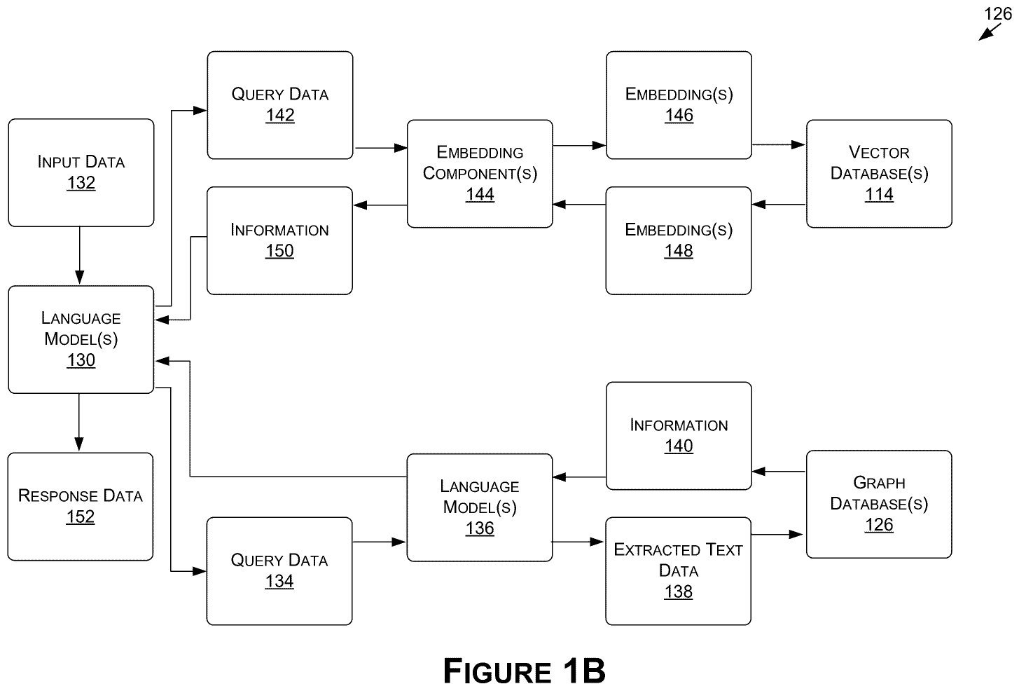

With reference to FIG. 1A, FIG. 1A illustrates an example of a process 100 for generating interaction graphs associated with videos, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more image sensors 102 (e.g., one or more cameras) generating video data 104 representing one or more videos. As described herein, the image sensor(s) 102 may be associated with one or more objects and/or an environment, such as by being located on and/or within a structure (e.g., a warehouse), located on a machine (e.g., a vehicle), and/or the like. Additionally, the video(s) may depict at least entities and/or interactions between the entities. In some examples, an entity may include, but is not limited to, a person, a vehicle, a machine, an animal, equipment, a shelf, a box, and/or any other type of object. Additionally, an interaction may include, but is not limited to, approaching an entity, walking away from an entity, instructing an entity, pushing an entity, placing an entity, lifting an entity, carrying an entity, driving an entity, causing a collision with an entity, and/or any other type of interaction that may occur between two or more entities. In some examples, the video data 104 may represent additional information, such as timestamps indicating when frames of the video(s) were generated using the image sensor(s) 102 and/or identifiers indicating which image sensor generated a respective video.

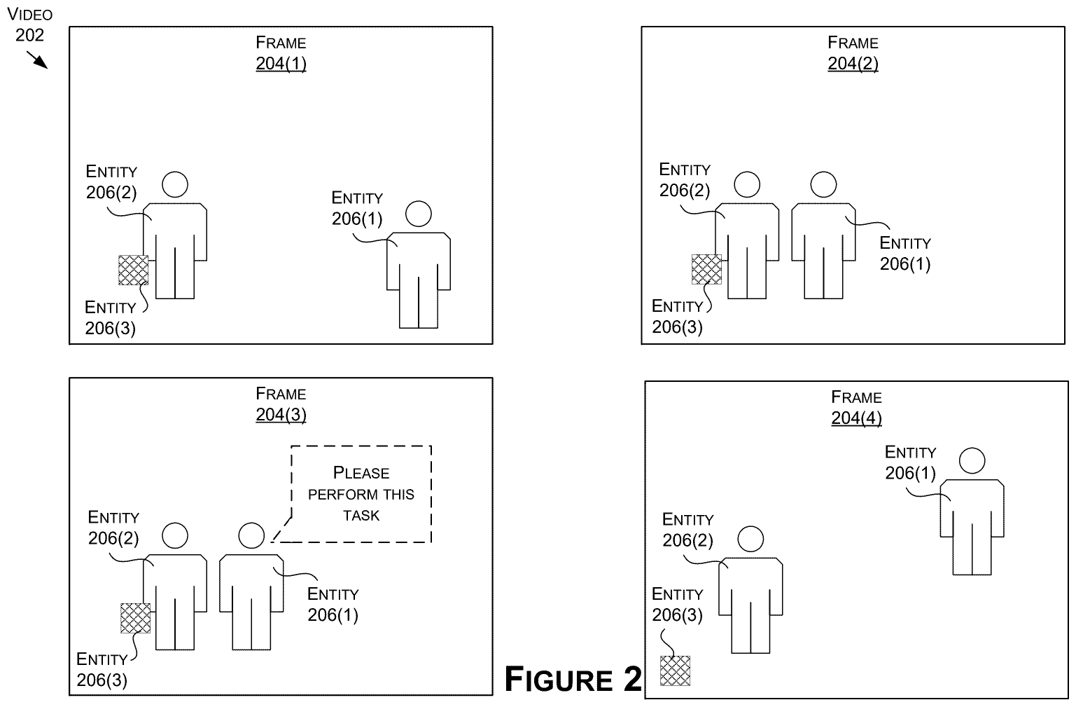

For instance, FIG. 2 illustrates an example of a video 202 that represents interactions between entities, in accordance with some embodiments of the present disclosure. As shown, the video 202 includes frames 204(1)-(4) (also referred to singularly as “frame 204” or in plural as “frames 204”) that depict entities 206(1)-(3) (also referred to singularly as “entity 206” or in plural as “entities 206”). Additionally, the frames 204 depict different interactions that may occur between the entities 206. For instance, the first frame 204(1) represents the second entity 206(2) caring the third entity 206(3). Additionally, the second frame 204(2) represents the first entity 206(1) approaching the second entity 206(2) and/or the second entity 206(2) still carrying the third entity 206(3). Furthermore, the third frame 204(3) represents the first entity 206(1) providing instructions to the second entity 206(2) and/or the second entity 206(2) still carrying the third entity 206(3). Moreover, the fourth frame 204(4) represents the first entity 206(1) walking away from the second entity 206(2) and/or the second entity 206(2) placing the third entity 206(3) on the ground.

Referring back to the example of FIG. 1A, the process 100 may include one or more video processors 106 processing the video data 104 in order to generate CV data 108 associated with the video(s). As described herein, the video processor(s) 106 may use and/or include one or more models—such as one or more CV models—and/or any other type of processing component to perform one or more of the processes described herein. Additionally, in some examples, information represented by the CV data 108 may include, but is not limited to, identifiers (e.g., names, usernames, general identifiers, etc.) of the entities, locations of the entities within the frames, bounding shapes (e.g., bounding boxes) representing portions of the frames that depict the entities, attributes (e.g., colors, textures, patterns, etc.) associated with the entities, actions being performed by the entities, and/or any other information. In some examples, the video processor(s) 106 may generate respective CV data 108 associated with each frame of the video(s). Additionally, or alternatively, in some examples, the video processor(s) 106 may generate respective CV data 108 for multiple frames of the video(s).

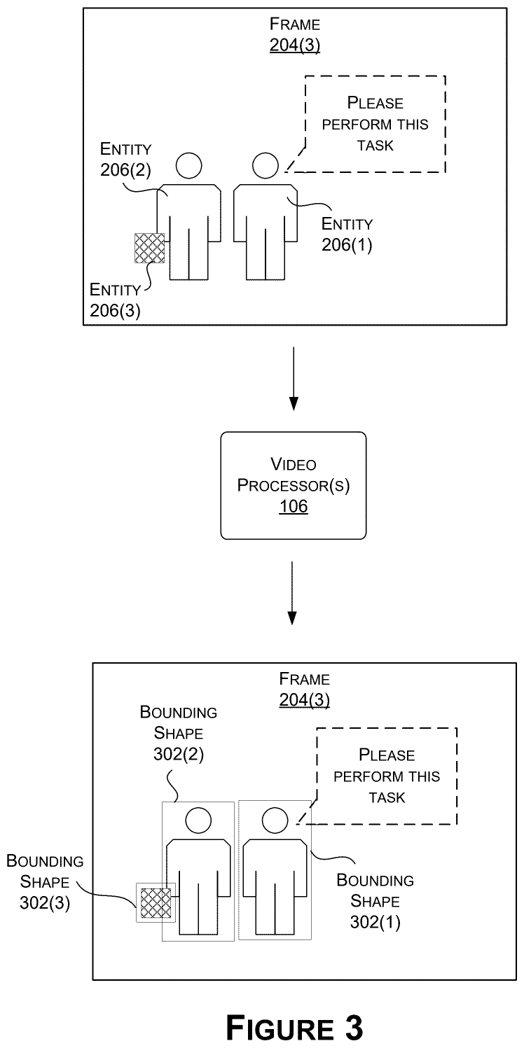

For instance, FIG. 3 illustrates an example of generating computer-vision information associated with the third frame 204(3) of the video 202, in accordance with some embodiments of the present disclosure. As shown, the video processor(s) 106 may determine the CV information to include at least a first bounding shape 302(1) associated with the first entity 206(1), a second bounding shape 302(2) associated with the second entity 206(2), and a third bounding shape 302(3) associated with the third entity 206(3). However, in other examples, the video processor(s) 106 may determine additional CV information associated with the third frame 204(3), such as the identifiers (e.g., names, usernames, general identifiers, etc.) of the entities 206 and/or attributes associated with the entities 206. Additionally, in some examples, the video processor(s) 106 may determine CV information associated with one or more of the other frames 204 of the video 202.

Referring back to the example of FIG. 1A, the process 100 may include one or more language models 110 processing the video data 104 and/or the CV data 108 to generate description data 112 representing descriptions associated with the frames of the video(s). As described herein, the language model(s) 110 may include any type of language model—such as one or more vision-language models—that is configured to perform at least a portion of the processing described herein. Additionally, in some examples, a description associated with a frame may describe identifiers for the entities depicted by the frame, a location the frame depicts, a time the frame was generated, one or more interactions between the entities as depicted by the frame, the attributes associated with the entities, and/or any other information associated with the frame. In some examples, the language model(s) 110 may generate a respective description for each frame of the video(s). Additionally, or alternatively, in some examples, the language model(s) 110 may generate a respective description for multiple frames of the video(s).

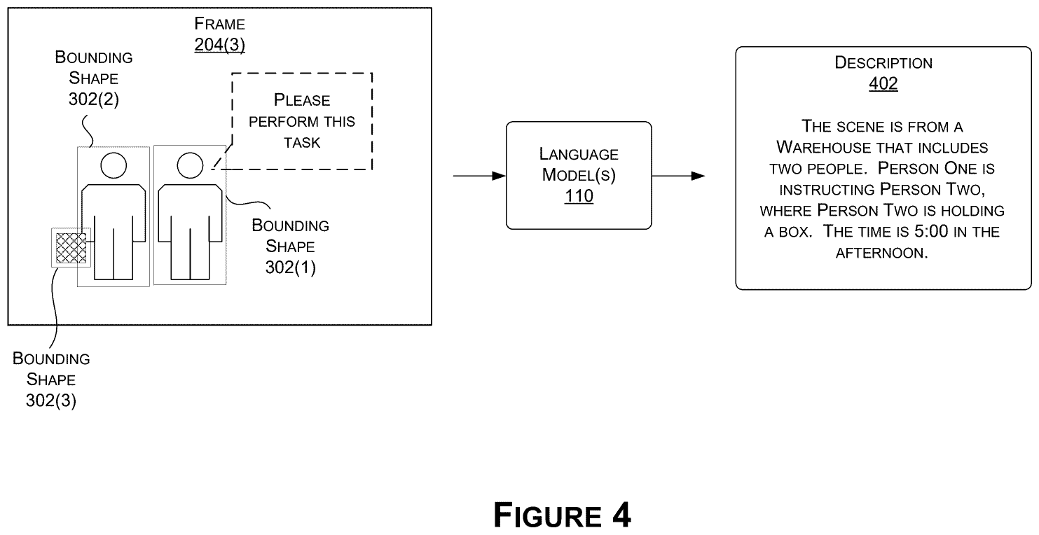

For instance, FIG. 4 illustrates an example of generating a description 402 associated with the third frame 204(3) of the video 202, in accordance with some embodiments of the present disclosure. As shown, the language model(s) 110 may process input data representing the third frame 204(3) and/or the CV information associated with the third frame 204(3). Based at least on the processing, the language model(s) 110 may generate the data representing the description 402 for the third frame 204(3). As shown, the description 402 includes information associated with the third frame 204(3), such as the identities of the entities 206 (e.g., Person One and Person Two), the type of environment depicted (e.g., a warehouse), an interaction that is occurring between the entities 206(1)-(2) (e.g., the first entity 206(1) is instructing the second entity 206(2)), and a time that the instruction occurred (e.g., 5:00). In some examples, the language model(s) 110 may perform similar processes to generate one or more additional descriptions associated with one or more other frames 204 of the video 202.

Referring back to the example of FIG. 1A, the process 100 may include storing the CV data 108 and/or the description data 112 in one or more databases, such as one or more vector databases 114. As shown, in some examples, to store the data, the process 100 may include one or more embedding components 116 processing the descriptions represented by the description data 112 (and/or, in some examples, the CV information represented by the CV data 108) to generate embeddings 118 associated with the descriptions (and/or the CV information). For example, the embedding component(s) 116 may include one or more encoders (and/or any other type of processing component) that are configured to generate the embeddings 118. The process 100 may then include storing the embeddings 118 in the vector database(s) 114.

The process 100 may further include one or more language models 120 processing at least the description data 112 to generate extracted text data 122 representing summaries associated with the frames and/or the descriptions. As described herein, the language model(s) 120 may include any type of language model—such as one or more text2cypher language models —that are configured to perform at least a portion of the processes described herein. Additionally, the summaries may use one or more specific types of languages—such as a Cypher Query Language (and/or any other type of query language)—associated with searching for and/or retrieving information. For example, a summary associated with a description and/or a frame may include specific information, such as one or more entities depicted by the frame, one or more interactions represented by the frame, and/or a timestep associated with the frame.

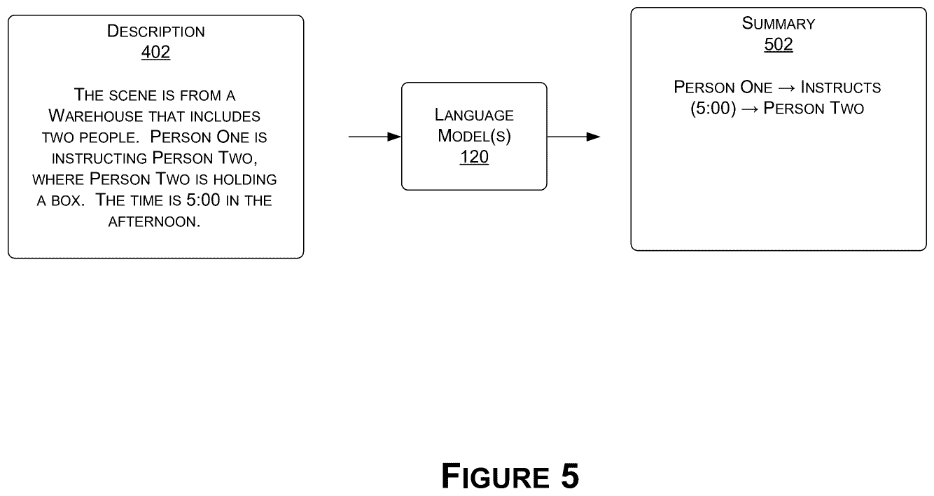

For instance, FIG. 5 illustrates an example process of generating a summary 502 associated with the description 402 and/or the third frame 204(3) of the video 202, in accordance with some embodiments of the present disclosure. As shown, the language model(s) 120 may determine the summary 502 as including at least an identifier associated with the first entity 206(1) (e.g., Person One), an identifier associated with the second entity 206(2) (e.g., Person Two), the interaction that occurs between the first entity 206(1) and the second entity 206(2) (e.g., instructs), and the time that the third frame 204(3) was generated (e.g., 5:00). However, in other examples, the summary 502 may include additional information associated with the third frame 204(3), such as at least a portion of the CV information represented by CV data associated with the third frame 204(3) (e.g., the attributes associated with the entities 206). Additionally, in some examples, the language model(s) 120 may determine summaries associated with one or more of the other frames 204 of the video 202.

Referring back to the example of FIG. 1A, the process 100 using one or more graph models 124 to generate and/or update a graph associated with the video data 104, where the graph may be stored in one or more graph databases 126. As described herein, the graph model(s) 124 may include any type of processing, such as one or more language models, that is configured to take the summaries represented by the extracted text data 122 and generate the graph. In some examples, the graph may represent at least interactions between entities as represented by the video(s). For instance, the graph may include nodes associated with the entities, such as nodes that represent identifiers of the entities and/or attributes associated with the entities (e.g., the CV information). Additionally, the graph may include edges associated with interactions that occurred between the entities and/or timestamps indicating when the interactions occurred. In some examples, the graph may initially be generated using one or more initial summaries associated with one or more initial frames, such as with one or more initial nodes and/or edges. In such examples, the graph may then be updated as new summaries associated with new frames are generated and/or received, such as with one or more new nodes and/or edges. Still, in some examples, at least a portion of the graph may be generated using the CV data 108.

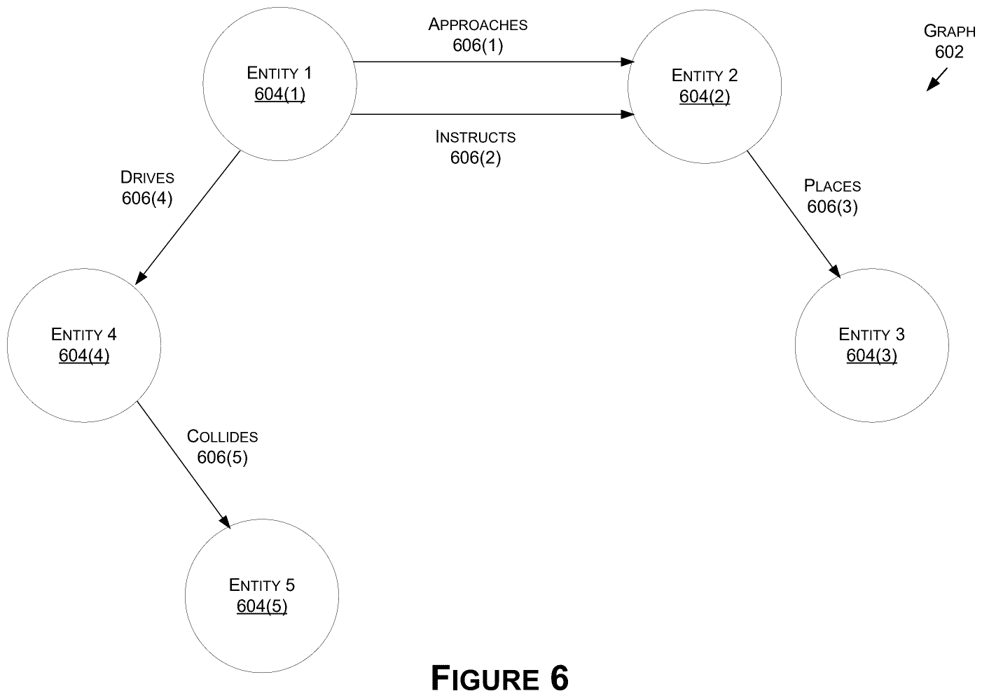

For instance, FIG. 6 illustrates an example process of generating an interaction graph 602 associated with the video 202, in accordance with some embodiments of the present disclosure. In some examples, the graph 602 may be generated to include at least a first node 604(1) associated with the first entity 206(1) and a second node 604(2) associated with the second entity 206(2) using a summary associated with the first frame 204(1). Next, the graph 602 may be updated to include a first edge 606(1) associated with a first interaction between the first entity 206(1) and the second entity 206(1) using a summary associated with the second frame 204(2), where the first interaction includes the first entity 206(1) approaching the second entity 206(2).

Next, the graph 602 may be updated to include a second edge 606(2) associated with a second interaction between the first entity 206(1) and the second entity 206(2) using the summary 503 associated with the third frame 204(3), where the second interaction includes the first entity 206(1) instructing the second entity 206(2). Finally, the graph 602 may be updated to include a third node 604(3) associated with the third entity 206(3) and a third edge 606(3) associated with a third interaction between the second entity 206(2) and the third entity 206(3) using a summary associated with the fourth frame 204(4), where the third interaction includes the second entity 206(2) placing the third entity 206(3).

As shown, these processes may then continue to repeat as additional frames associated with the video 202 are processed using one or more of the processes described herein. For instance, additional frames may depict the first entity 206(1) interacting with a fourth entity (e.g., a machine), such as by driving the fourth entity. As such, the graph 602 may be updated to include a fourth node 604(4) associated with the fourth entity and fourth edge 606(4) associated with the interaction between the first entity 206(1) and the fourth entity, where the interaction includes the first entity 206(1) driving the fourth entity. Next, additional frames may depict the fourth entity interacting with a fifth entity (e.g., a shelf), such as by colliding with the fifth entity. As such, the graph 602 may be updated to include a fifth node 604(5) associated with the fifth entity and a fifth edge 606(5) associated with the interaction between the fourth entity and the fifth entity, where the interaction includes the fourth entity colliding with the fifth entity.

In some examples, the nodes 604(1)-(5) (also referred to singularly as “node 604” or in plural as “nodes 604”) and/or the edges 606(1)-(5) (also referred to singularly as “edge 606” or in plural as “edges 606”) may include additional information associated with the video 202. For example, the nodes 604 may include information describing the entities 206, such as attributes associated with the entities 206. Additionally, the edges 606 may include information describing the interactions, such as timestamps indicating when the interactions occurred and/or identifiers of the frames 204 that are associated with the interactions. As such, the graph 602 may represent one or more (e.g., all) of the interactions that occur between one or more (e.g., all) of the entities 206 as depicted by the video 202.

In some examples, and as further illustrated by the example of FIG. 6, the graph 602 may include a format—such as a document, a spreadsheet, a memo, and/or the like—that is viewable by users. For example, a user may view the graph 602 to identify the entities 206 associated with the video 202, the interactions that occurred between the entities 206, and/or additional information associated with the interactions (e.g., the times that the interactions occurred). Additionally, in some examples and as described in more detail herein, the graph 602 may include a format that is searchable by one or more systems for identifying information associated with the video 202.

Referring back to the example of FIG. 1A, while the example of FIG. 1A illustrates the graph database(s) 126 as being separate from the vector database(s) 114, in other examples, at least a portion of the data form the vector database(s) 114 may be stored in the graph database(s) 126, at least a portion of the data from the graph database(s) 126 may be stored in the vector database(s) 114, and/or the graph database(s) 126 and the vector data base(s) 114 may be combined into one or more databases. The process 100 may continue to repeat in order to add additional data to the vector database(s) 114, update the graph stored in the graph database(s) 126, and/or generate new graphs associated with new videos. Additionally, as described herein, after generating the graphs, the graphs may be used to perform various tasks, such as information retrieval. For instance, FIG. 1B illustrates an example of a process 128 for performing information retrieval using interaction graphs, in accordance with some embodiments of the present disclosure.

The process 128 may include one or more language models 130 processing input data 132 associated with at least a query. As described herein, the input data 132 may include, but is not limited to, audio data representing user speech associated with the query, text data representing text describing the query, selection data representing a selection of an interactive element describing (e.g., a button, etc.) the query, and/or any other type of input data. As such, in some examples, the input data 132 may be preprocessed before being received by the language model(s) 130 and/or processed using the language model(s) 130. For example, if the input data 132 represents audio data, then the audio data may be processed using one or more ASR models and/or one or more NLU models to generate a transcript associated with the user speech, where the ASR model(s) and/or the NLU model(s) may be represented by the language model(s) 130.

The process 100 may then include, based at least processing the input data 132, generating and/or outputting query data 134 representing the query. For instance, in some examples, the query data 134 may represent text corresponding to the query, such as one or more letters, numbers, words, sentences, symbols, and/or the like associated with the query. In some examples, the language model(s) 130 may generate an enhanced query for performing information retrieval. For example, the query data 134 may represent not only the query, but additional information for performing information retrieval, such as information associated with one or more nodes and/or edges of the graph.

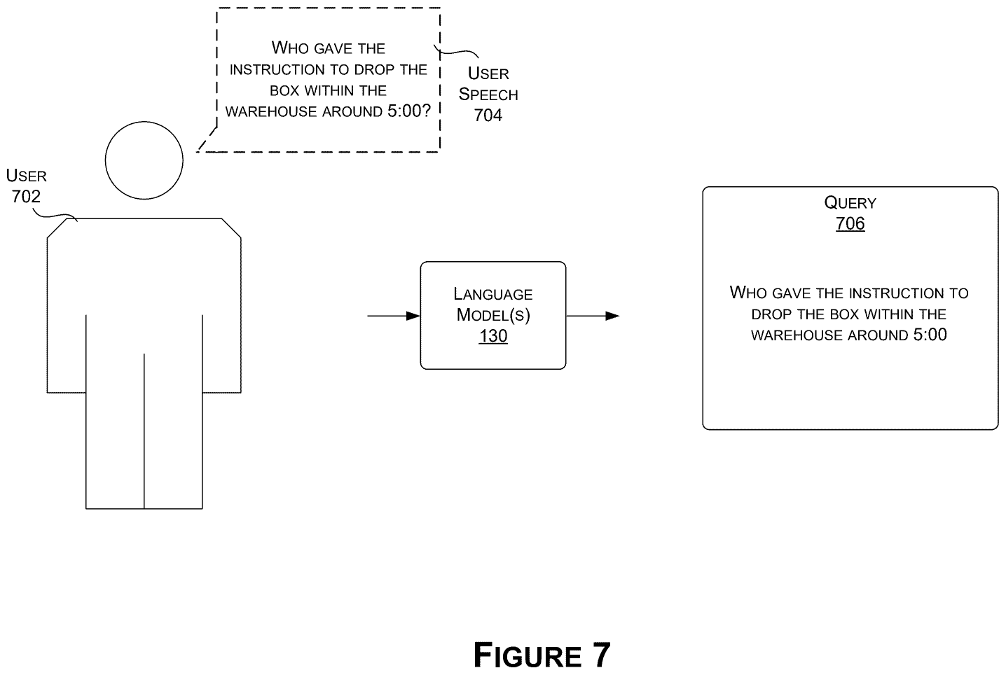

For instance, FIG. 7 illustrates an example process of generating a query associated with performing information retrieval, in accordance with some embodiments of the present disclosure. As shown, a user 702 may provide input in the form of user speech 704, where the input corresponds to a question about the video 202. For example, the question is associated with requesting information about the person that gave the instruction to drop the box at around 5:00. As such, the language model(s) 130 may process audio data representing the user speech 704 and, based at least on the processing, generate data representing a query 706 corresponding to the user speech 704. In the example of FIG. 7, the query 706 may include a transcript of the user speech 704. However, in other examples, the query 706 may include any other type of representation of the user speech 704.

Referring back to the example of FIG. 1B, the process 128 may include one or more language models 136 processing at least the query data 134 to generate extracted text data 138 representing a summary associated with the query. As described herein, the language model(s) 136 may include any type of language model—such as one or more text2cypher language models —that are configured to perform at least a portion of the processes described herein. For instance, in some examples, the language model(s) 136 may include the language model(s) 120 from the example of FIG. 1A. Additionally, the summary may use one or more specific types of languages —such as a Cypher Query Language (and/or any other type of query language)—associated with searching for and/or retrieving information. For example, a summary associated with a query may include specific information from the query, such as one or more entities, one or more interactions, one or more timesteps, and/or one or more actions that should be performed for the information retrieval.

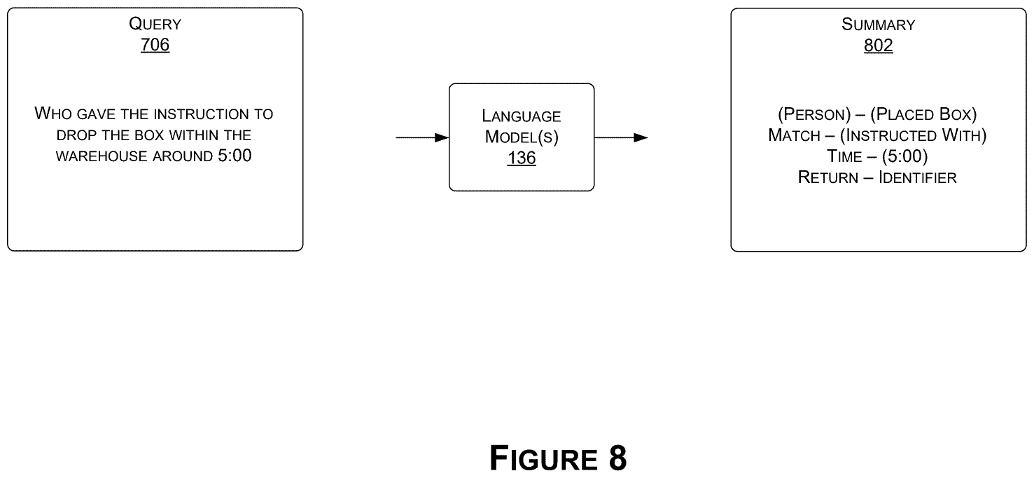

For instance, FIG. 8 illustrates an example process of generating a summary 802 associated with the query 706, where the summary 802 is used to perform information retrieval, in accordance with some embodiments of the present disclosure. As shown, the summary 802 may include at least information associated with the entities 206 from the query 706, which include person and box, the interactions from the query 706, which include providing instructions and placing the box, and the time from the query 706, which includes 5:00. Additionally, the summary 802 includes an action that should be performed with regard to the information retrieval, which includes retrieving a name of a person. However, in other examples, the summary 802 may include additional and/or alternative information for performing the information retrieval. For example, the summary 802 may include any information that may help in searching through the graph to perform the information retrieval.

Referring back to the example of FIG. 1B, the process 100 may include using the summary to search through the graph and retrieve information 140 associated with the query. As described herein, any type of search may be performed to identify the information 140 from the graph, such as matching text (e.g., words) from the summary with text (e.g., words) from the graph. For example, if the summary includes identifiers for one or more entities and/or interactions, then the graph may be searched to identify one or more nodes and/or edges that are associated with the identifier(s). These matches may then be used to identify the information 140, such as by retrieving the information 140 from the identified node(s) and/or edge(s) and/or retrieving the information 140 from one or more connected nodes and/or edges. For example, if an identifier from the summary is matched to a node, then information 140 associated with the node, information 140 associated with one or more connecting edges, and/or information 140 associated with one or more connected nodes may be retrieved.

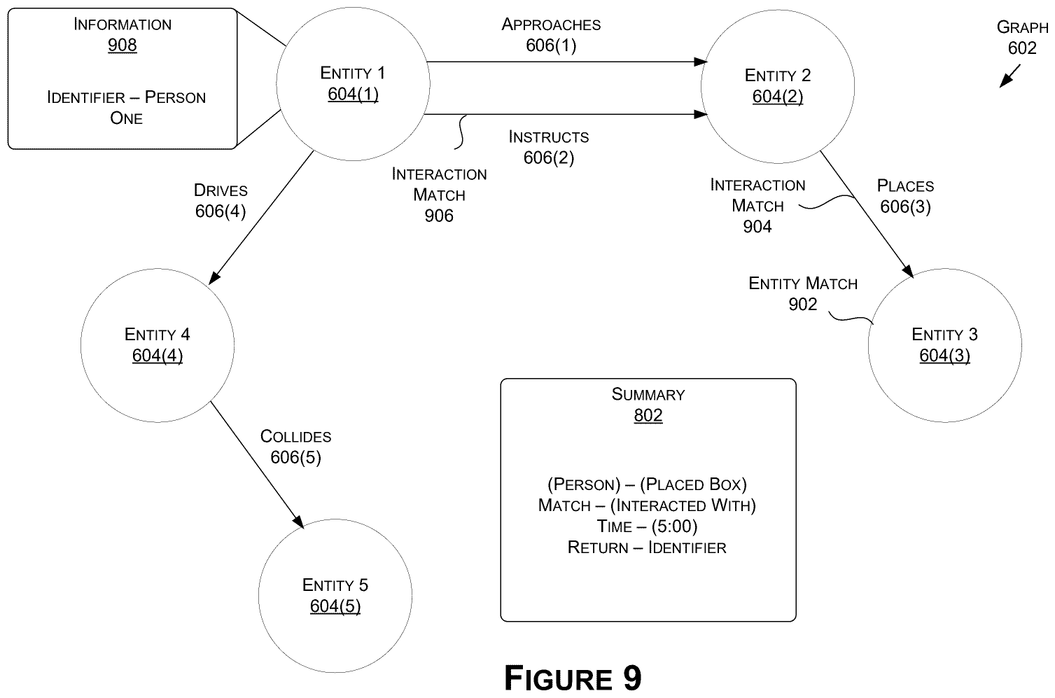

For instance, FIG. 9 illustrates an example process of using the summary 802 to retrieve information from the graph 602, in accordance with some embodiments of the present disclosure. As shown, the third entity 206(3) from the summary 802, which includes “box” in these examples, may initially be matched to the third node 604(3) that is associated with the third entity 206(3), which is indicated by 902. Next, the interaction from the summary 802, which includes “placing,” may be matched to the third edge 606(3) that is associated with the placing of the third entity 206(3), which is indicated by 904. As such, it may be determined that the second entity 206(2), which is associated with the second node 604(2), is the person that placed the box. However, the query 706 is requesting information for the other person that instructed the box to be placed.

As such, the other instruction from the summary 802, which includes “instructed,” may be matched to the second edge 606(2) that is associated with instructing the second entity 206(2) to place the third entity 206(3), which is indicated by 906. Finally, it may be determined that the first entity 206(1), which is associated with the first node 604(1), instructed the second entity 206(2) to place the third entity 206(3). Because of this, information 908 may be retrieved from the graph 602 that is associated with the first entity 206(1). For example, an identifier associated with the first entity 206(1) may be retrieved from the graph 602, which again includes Person One in these examples. However, in other examples, additional information may be retrieved from the graph 602, such as one or more attributes associated with the first entity 206(1) and/or an identifier of the second entity 206(2), which may also help when generating a response to the query 706.

In some examples, and as described herein, one or more filtering techniques may be used to improve the performance of retrieving the information 908 from the graph 602. For a first example, since the summary 802 includes a limiting term associated with a time period, which is 5:00, then only a portion of the graph 602 that is within a threshold time interval (e.g., 20 minutes, 1 hour, 2 hours, etc.) around the time period may be searched. For instance, if the graph 602 indicates that the approaches interaction associated with the first edge 606(1) occurred at 4:55, the instruction interaction associated with the second edge 606(2) occurred at 4:58, the placing interaction associated with the third edge 606(3) occurred at 5:00, the driving interaction associated with the fourth edge 606(4) occurred to 8:00, and the collision interaction associated with the fifth edge 606(5) occurred at 8:05, then a portion of the graph 602 that includes the nodes 604(4)-(5) and the edges 606(4)-(5) may not be searched when retrieving the information 908 for the query 706 since the edges 606(4)-(5) are associated with the interactions that occurred outside of the threshold time interval to 5:00.

For a second example, since the summary 802 includes limiting terms associated with types of entities, which include people and boxes, then only a portion of the graph 602 that is associated with those types of entities may again be searched. For instance, if the graph 602 indicates that the entities 206(1)-(3) associated with the nodes 604(1)-(3) include people and a box, but the entities 206(4)-(5) associated with the nodes 604(4)-(5) respectively include a machine and a shelf, then only a portion of the graph 602 that includes the nodes 604(1)-(3) may be searched when retrieving the information 908 for the query 706. While these are just a couple examples of using limiting terms from the summary 802 to filter the graph 602 when performing information retrieval, in other examples, additional and/or alternative limiting terms may be used to filter the graph 602 during information retrieval.

Referring back to the example of FIG. 1B, in some examples, the process 128 may include retrieving additional information related to the query. For instance, the process 128 may include the language model(s) 130 further generating and/or outputting query data 142 representing the query. As described herein, in some examples, the query data 142 may represent text corresponding to the query, such as one or more letters, numbers, words, sentences, symbols, and/or the like associated with the query. In some examples, the query data 142 used to retrieve the additional information may be similar to the query data 134 used to retrieve the information 140. However, in other examples, the query data 142 used to retrieve the additional information may be different that the query data 134 used to retrieve the information 140. For instance, and as described herein, the query data 134 may have been enhanced with additional information associated with the query, such as information from the graph, where the query data 142 is not enhanced with the same additional information.

The process 128 may then include using the query data 142 to retrieve one or more descriptions stored in the vector database(s) 114. For instance, and as shown, the process 128 may include using one or more embedding components 144 to process the query data 142 in order to generate one or more embeddings 146 associated with the query. In some examples, the embedding component(s) 144 may include the embedding component(s) 116 that was used to generate the embeddings 118 associated with the descriptions. However, in other examples, the embedding component(s) 144 may be different than the embedding component(s) 116.

The process 128 may then include using the embedding(s) 146 to search through the vector database(s) 114 to identify the additional information. As described herein, in some examples, any type of search may be used to identify the additional information. For example, based on the search, one or more embeddings 148 stored in the vector database(s) 114, which are similar to the embedding(s) 146, may be identified and/or retrieved. In some examples, information 140 from the graph may be used to perform the search for the additional information, such as by filtering the embeddings 118 that are searched. For a first example, if the information 140 indicates a time period (e.g., a timestamp) that an interaction associated with the query occurred, then the time period may be used to filter the embeddings 118 in order to search a portion of the embeddings 118 that are associated with the time period (e.g., are associated with frames generated within a threshold period of time to the time period). For a second example, if the information 140 indicates an identifier of an entity associated with the query, then the identifier may be used to filter the embeddings 118 in order to search a portion of the embeddings 118 that are associated with the identifier (e.g., include text describing the identifier).

As described herein, at least a portion of the embedding(s) 148 may be associated with one or more descriptions associated with the video(s). Additionally, or alternatively, in some examples, at least a portion of the embedding(s) 148 may be associated with additional information related to the video(s), such as the CV information. In any example, the process 128 may include providing the embedding(s) 148 as additional information 150 and/or decoding the embedding(s) 148 to generate text associated with the additional information 150.

The process 128 may then include the language model(s) 130 processing input data associated with the information 140 and/or the additional information 150 in order to generate and/or output response data 152 representing a response to the query. As described herein, in some examples, the response data 152 may include any type of data, such as text data representing text corresponding to the response, audio data representing speech corresponding to the response, image data representing a graphic associated with the response, and/or any other type of data. In some examples, additional data may be input into the language model(s) 130 to generate the response data 152, such as the input data 132, the query data 134, the query data 142, and/or prompt data representing a prompt associated with generating the response.

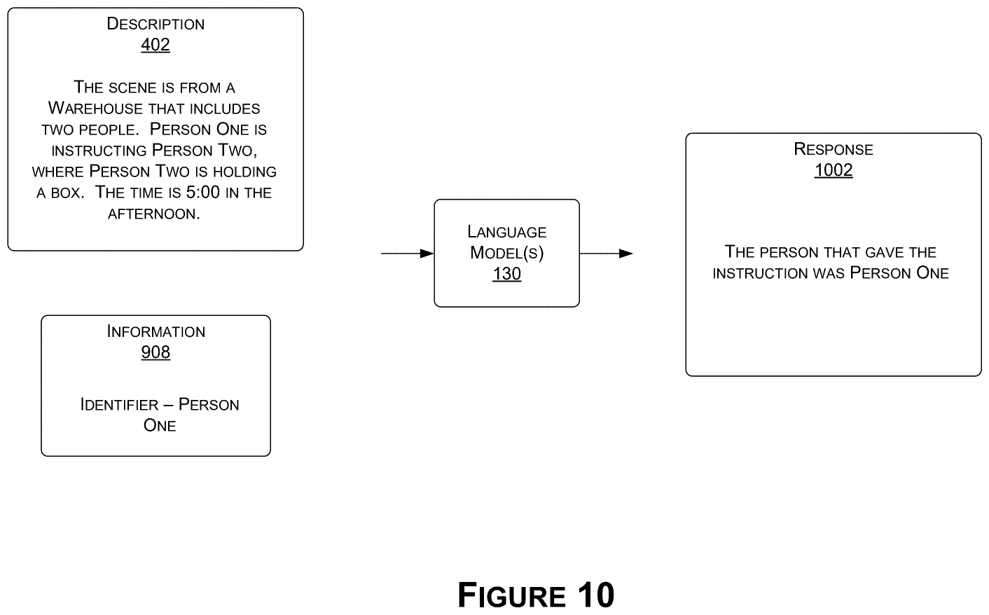

For instance, FIG. 10 illustrates an example process of using retrieved information to generate a response 1002 associated with the query 706, in accordance with some embodiments of the present disclosure. As shown, the input data to the language model(s) 130 may represent at least the information 908 that is retrieved from the graph 602 along with the description 402 that is retrieved from the vector database(s). Based at least on processing the input data, the language model(s) 130 may generate the response 1002. In the example of FIG. 10, the response 1002 includes the identifier of the person that provided the instruction to place the box, which again includes Person One in these examples.

Referring back to the example of FIG. 1B, in some examples, the process 128 may include retrieving additional data associated with the query. For example, one or more portions of the video(s) that depict information associated with the query may be retrieved and/or provided along with the response. In such examples, the information 140 retrieved from the graph may be used to identify the portion(s) of the video(s). For instance, if the information 140 indicates a time period associated with the query, then the time period may be used to identify the portion(s) of the video(s) that was generated within a threshold time interval to the time period.

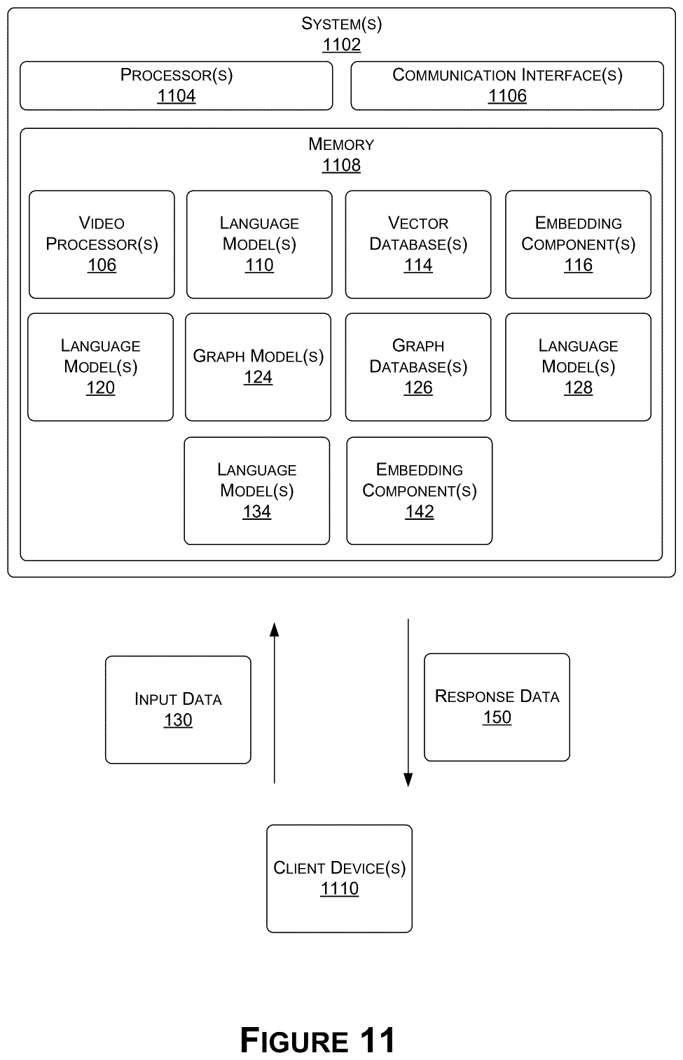

FIG. 11 illustrates an example of one or more systems 1102 that may be configured to perform one or more of the processes described herein, in accordance with some embodiments of the present disclosure. As shown, the system(s) 1102 may include one or more processors 1104 (which may include, and/or be similar to, a CPU(s) 1526 and/or a GPU(s) 1528), one or more communication interfaces 1106 (which may include, and/or be similar to, a communication interface(s) 1510), and memory 1108 (which may include, and/or be similar to, a memory 1524). However, in other examples, the system(s) 1102 may include additional and/or alternative components, such as the image sensor(s) 102.

As shown, the memory 1108 may store the video processor(s) 106, the language model(s) 110, the vector database(s) 114, the embedding component(s) 116, the language model(s) 120, the graph database(s) 126, the language model(s) 130, the language model(s) 136, and/or the embedding component(s) 144. Additionally, the processor(s) 1104 may execute the video processor(s) 106, the language model(s) 110, the vector database(s) 114, the embedding component(s) 116, the language model(s) 120, the graph database(s) 126, the language model(s) 130, the language model(s) 136, and/or the embedding component(s) 144 to perform one or more of the processes described herein, such as the process 100 from the example of FIG. 1A and/or the process 128 from the example of FIG. 1B.

For instance, one or more client devices 1110 may send the input data 132 to the system(s) 1102. As described herein, the input data 132 may represent one or more queries for information related to one or more videos. The system(s) 1102 may then perform one or more of the processes described herein to generate one or more responses associated with the one or more queries. Additionally, the system(s) 1102 may send, to the client device(s) 1110, the response data 152 representing the response(s).

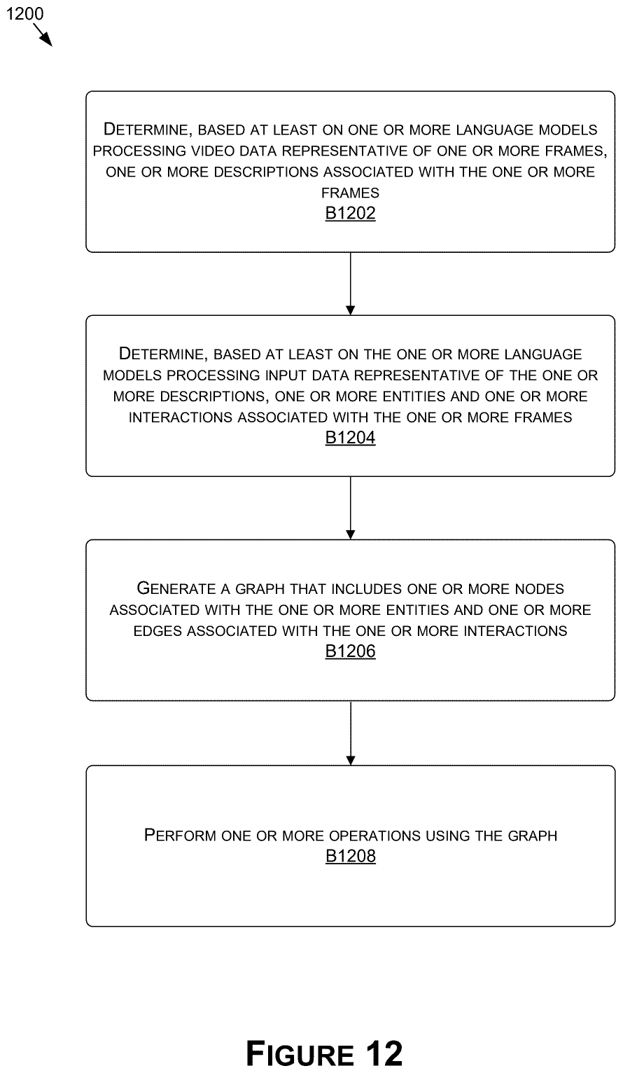

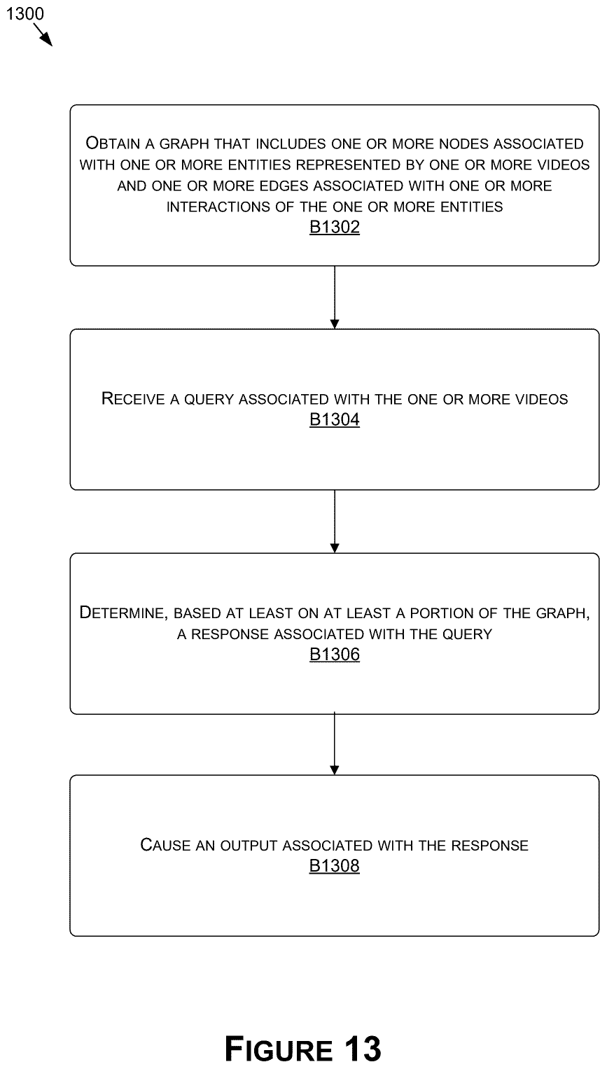

Now referring to FIGS. 12-13, each block of methods 1200 and 1320, described herein, comprises a computing process that may be performed using any combination of hardware, firmware, and/or software. For instance, various functions may be carried out by a processor executing instructions stored in memory. The methods 1200 and 1320 may also be embodied as computer-usable instructions stored on computer storage media. The methods 1200 and 1320 may be provided by a standalone application, a service or hosted service (standalone or in combination with another hosted service), or a plug-in to another product, to name a few. In addition, the methods 1200 and 1320 are described, by way of example, with respect to FIGS. 1A-1B. However, these methods 1200 and 1320 may additionally or alternatively be executed by any one system, or any combination of systems, including, but not limited to, those described herein.

FIG. 12 illustrates a flow diagram showing a method 1200 for generating an interaction graph associated with one or more videos, in accordance with some embodiments of the present disclosure. The method 1200, at block B1202, may include determining, based at least on one or more language models processing video data representative of one or more frames, one or more descriptions associated with the one or more frames. For instance, the language model(s) 110 may process the video data 104 in order to generate the description data 112 representing the description(s) associated with the frame(s). As described herein, in some examples, the language model(s) 110 may process additional data to generate the description(s), such as the CV data 108 generated using the video processor(s) 106.

The method 1200, at block B1204, may include determining, based at least on the one or more language models processing input data representative of the one or more descriptions, one or more entities and one or more interactions associated with the one or more frames. For instance, the language model(s) 120 may process the description data 112 to generate the extracted text data 122 representing one or more summaries associated with the description(s). As described herein, the one or more summaries may include at least one or more identifiers associated with the one or more entities and the interaction(s) that occurred between the one or more entities. Additionally, the one or more summaries may be associated with a specific type of language, such as a Cypher Query Language (and/or any other type of query language).

The method 1200, at block B1206, may include generating a graph that includes one or more nodes associated with the one or more entities and one or more edges associated with the one or more interactions. For instance, the graph may be generated to include the node(s) associated with the one or more entities and the edge(s) associated with the interaction(s). As described herein, in some examples, the graph may be generated to include additional information associated with the video(s). For a first example, the graph may be generated such that the node(s) is further associated with one or more attributes associated with the one or more entities. Additionally, the graph may be generated such that the edge(s) is further associated with one or more timestamps indicating when the interaction(s) occurred.

The method 1200, at block B1208, may include performing one or more operations using the graph. For instance, the graph may be stored in the graph database(s) 126, provided to one or more users to view, analyzed to perform information retrieval, and/or used to perform any other type of operation.

FIG. 13 illustrates a flow diagram showing a method 1320 for performing information retrieval using an interaction graph, in accordance with some embodiments of the present disclosure. The method 1320, at block B1322, may include obtaining a graph that includes one or more nodes associated with one or more entities represented by one or more videos and one or more edges associated with one or more interactions of the one or more entities. For instance, the graph that includes the node(s) associated with the one or more entities and the edge(s) associated with the interaction(s) may be obtained, such as from the graph database(s) 126. As described herein, the graph may represent additional information associated with the video(s), such as attributes associated with the one or more entities and/or timestamps associated with the interaction(s).

The method 1320, at block B1324, may include receiving a query associated with the one or more videos. For instance, the language model(s) 130 may receive the input data 132 associated with the query. As described herein, the input data 132 may include audio data, text data, selection data, and/or any other type of input data. The language model(s) 130 may then process the input data 132 to generate the query data 134 (and/or the query data 142) representing the query.

The method 1320, at block B1326, may include determining, based at least on at least a portion of the graph, a response associated with the query. For instance, the query data 134 may be used to retrieve the information 140 from the graph. Additionally, in some examples, the query data 142 may also be used to retrieve the additional information 150 from the vector database(s) 114. The language model(s) 130 may then process input data representing the information 140 and/or the additional information 150. Based at least on the processing, the language model(s) 130 may generate the response data 152 representing the response to the query. In some examples, additional data may be retrieved for the query, such as one or more portions of the video(s) associated with the query.

The method 1320, at block B1328, may include causing a response associated with the query to be output. For instance, the response may be output, such as by outputting speech representing the response, displaying text representing the response, displaying content representing the response, and/or using any other technique.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein-may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model —or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

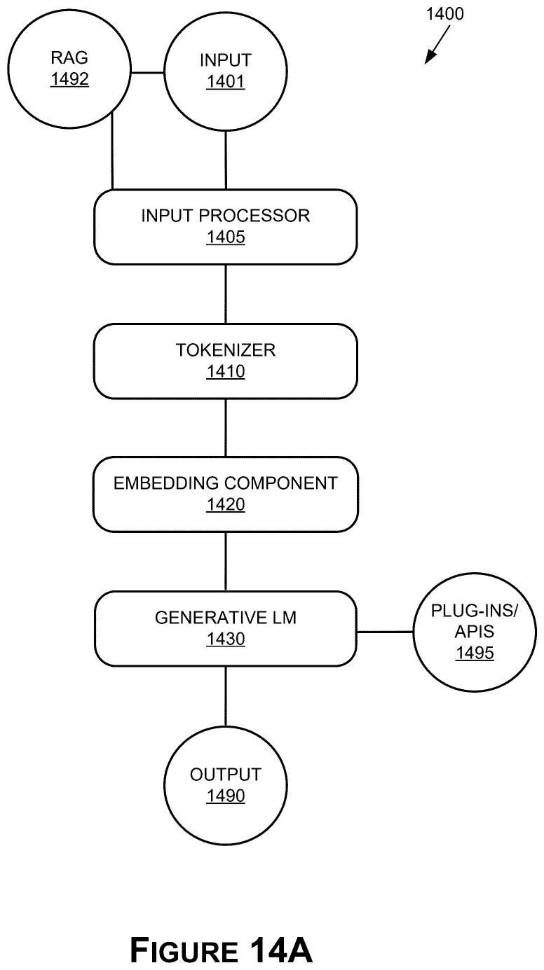

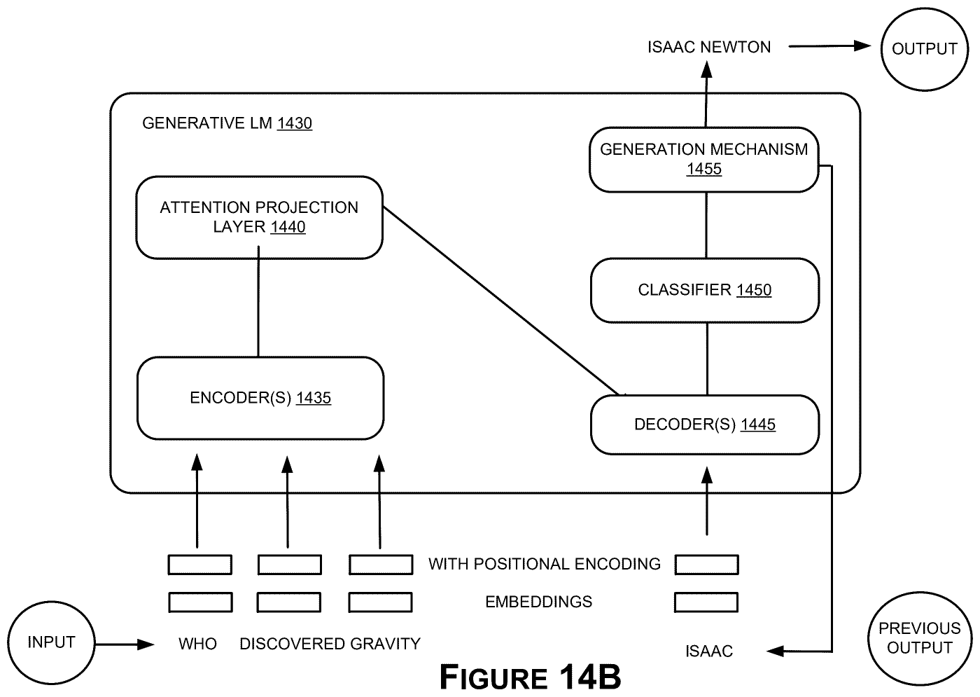

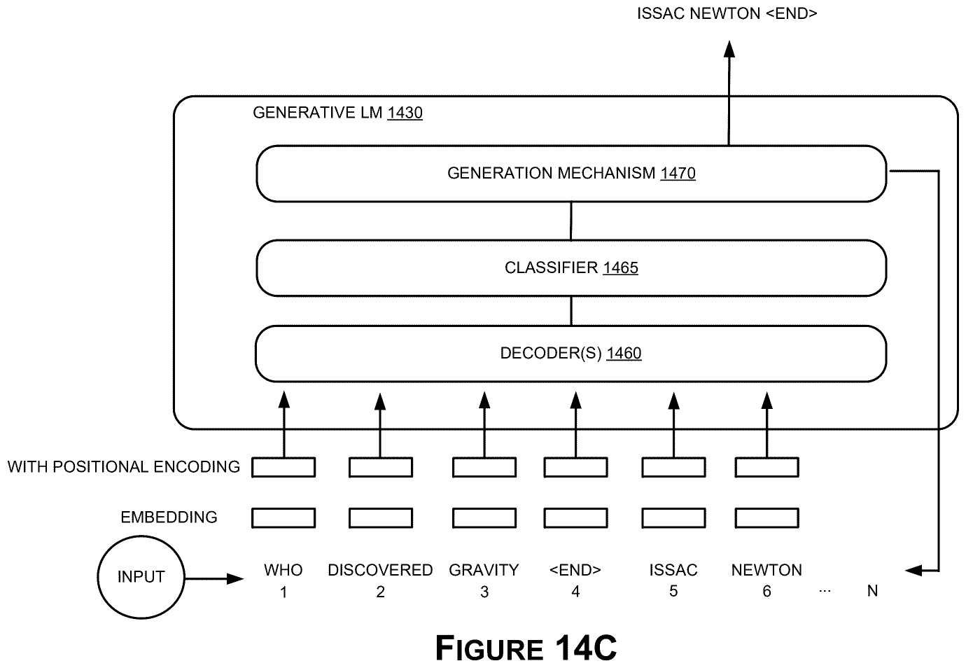

FIG. 14A is a block diagram of an example generative language model system 1400 suitable for use in implementing at least some embodiments of the present disclosure. In the example illustrated in FIG. 14A, the generative language model system 1400 includes a retrieval augmented generation (RAG) component 1492, an input processor 1405, a tokenizer 1410, an embedding component 1420, plug-ins/APIs 1495, and a generative language model (LM) 1430 (which may include an LLM, a VLM, a multi-modal LM, etc.).

At a high level, the input processor 1405 may receive an input 1401 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1430 (e.g., LLM/VLM/MMLM/etc.). In some embodiments, the input 1401 includes plain text in the form of one or more sentences, paragraphs, and/or documents. Additionally or alternatively, the input 1401 may include numerical sequences, precomputed embeddings (e.g., word or sentence embeddings), and/or structured data (e.g., in tabular formats, JSON, or XML). In some implementations in which the generative LM 1430 is capable of processing multi-modal inputs, the input 1401 may combine text (or may omit text) with image data, audio data, video data, design data, USD data, and/or other types of input data, such as but not limited to those described herein. Taking raw input text as an example, the input processor 1405 may prepare raw input text in various ways. For example, the input processor 1405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1405 may remove stopwords to reduce noise and focus the generative LM 1430 on more meaningful content. The input processor 1405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1492 (which may include one or more RAG models, and/or may be performed using the generative LM 1430 itself) may be used to retrieve additional information to be used as part of the input 1401 or prompt. RAG may be used to enhance the input to the LLM/VLM/MMLM/etc. with external knowledge, so that answers to specific questions or queries or requests are more relevant—such as in a case where specific knowledge is required. The RAG component 1492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1401 may be generated using the query or input to the model (e.g., a question, a request, etc.) in addition to data retrieved using the RAG component 1492. In some embodiments, the input processor 1405 may analyze the input 1401 and communicate with the RAG component 1492 (or the RAG component 1492 may be part of the input processor 1405, in embodiments) in order to identify relevant text and/or other data to provide to the generative LM 1430 as additional context or sources of information from which to identify the response, answer, or output 1490, generally. For example, where the input indicates that the user is interested in a desired tire pressure for a particular make and model of vehicle, the RAG component 1492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1492 may retrieve a prior stored conversation history—or at least a summary thereof—and include the prior conversation history along with the current ask/request as part of the input 1401 to the generative LM 1430.

The RAG component 1492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1492 and the embeddings of the chunks along with the embeddings of the query may be compared to identify the most similar/related embeddings to the query, which may be supplied to the generative LM 1430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1430 to understand morphological variations and handle out-of-vocabulary words more effectively. Character-based tokenization represents each character as a separate token, enabling the generative LM 1430 to process text at a fine-grained level. The choice of tokenization strategy may depend on factors such as the language being processed, the task at hand, and/or characteristics of the training dataset. As such, the tokenizer 1410 may convert the (e.g., processed) text into a structured format according to tokenization schema being implemented in the particular embodiment.

The embedding component 1420 may use any known embedding technique to transform discrete tokens into (e.g., dense, continuous vector) representations of semantic meaning. For example, the embedding component 1420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1401 includes image data/video data/etc., the input processor 1401 may resize the data to a standard size compatible with format of a corresponding input channel and/or may normalize pixel values to a common range (e.g., 0 to 1) to ensure a consistent representation, and the embedding component 1420 may encode the image data using any known technique (e.g., using one or more convolutional neural networks (CNNs) to extract visual features). In some implementations in which the input 1401 includes audio data, the input processor 1401 may resample an audio file to a consistent sampling rate for uniform processing, and the embedding component 1420 may use any known technique to extract and encode audio features—such as in the form of a spectrogram (e.g., a mel-spectrogram). In some implementations in which the input 1401 includes video data, the input processor 1401 may extract frames or apply resizing to extracted frames, and the embedding component 1420 may extract features such as optical flow embeddings or video embeddings and/or may encode temporal information or sequences of frames. In some implementations in which the input 1401 includes multi-modal data, the embedding component 1420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1430 and/or other components of the generative LM system 1400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1420 may apply an encoded representation of the input 1401 to the generative LM 1430, and the generative LM 1430 may process the encoded representation of the input 1401 to generate an output 1490, which may include responsive text and/or other types of data.

As described herein, in some embodiments, the generative LM 1430 may be configured to access or use—or capable of accessing or using—plug-ins/APIs 1495 (which may include one or more plug-ins, application programming interfaces (APIs), databases, data stores, repositories, etc.). For example, for certain tasks or operations that the generative LM 1430 is not ideally suited for, the model may have instructions (e.g., as a result of training, and/or based on instructions in a given prompt, such as those retrieved using the RAG component 1492) to access one or more plug-ins/APIs 1495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1495 to the plug-in/API 1495, the plug-in/API 1495 may process the information and return an answer to the generative LM 1430, and the generative LM 1430 may use the response to generate the output 1490. This process may be repeated—e.g., recursively—for any number of iterations and using any number of plug-ins/APIs 1495 until an output 1490 that addresses each ask/question/request/process/operation/etc. from the input 1401 can be generated. As such, the model(s) may not only rely on its own knowledge from training on a large dataset(s) and/or from data retrieved using the RAG component 1492, but also on the expertise or optimized nature of one or more external resources—such as the plug-ins/APIs 1495.

FIG. 14B is a block diagram of an example implementation in which the generative LM 1430 includes a transformer encoder-decoder. For example, assume input text such as “Who discovered gravity” is tokenized (e.g., by the tokenizer1410 of FIG. 14A) into tokens such as words, and each token is encoded (e.g., by the embedding component 1420 of FIG. 914A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1435 of the generative LM 1430.

In an example implementation, the encoder(s) 1435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1440 may convert the context vector into attention vectors (keys and values) for the decoder(s) 1445.

In an example implementation, the decoder(s) 1445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1435, in an example transformer architecture, each token (e.g., word) flows through a separate path in the decoder(s) 1445. During a first pass, the decoder(s) 1445, a classifier 1450, and a generation mechanism 1455 may generate a first token, and the generation mechanism 1455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1435, except that it creates its queries from the layer below it and takes the keys and values (e.g., matrix) from the output of the encoder(s) 1435.

As such, the decoder(s) 1445 may output some decoded (e.g., vector) representation of the input being applied during a particular pass. The classifier 1450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1455 may select or sample a word or token based on a corresponding predicted probability (e.g., select the word with the highest predicted probability) and append it to the output from a previous pass, generating each word or token sequentially. The generation mechanism 1455 may repeat the process, triggering successive decoder inputs and corresponding predictions until selecting or sampling a symbol or token that represents the end of the response, at which point, the generation mechanism 1455 may output the generated response.

FIG. 14C is a block diagram of an example implementation in which the generative LM 1430 includes a decoder-only transformer architecture. For example, the decoder(s) 1460 of FIG. 14C may operate similarly as the decoder(s) 1445 of FIG. 14B except each of the decoder(s) 1460 of FIG. 14C omits the encoder-decoder self-attention layer (since there is no encoder in this implementation). As such, the decoder(s) 1460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1460. As with the decoder(s) 1445 of FIG. 14B, each token (e.g., word) may flow through a separate path in the decoder(s) 1460, and the decoder(s) 1460, a classifier 1465, and a generation mechanism 1470 may use auto-regression to sequentially generate one token at a time until predicting a symbol or token that represents the end of the response. The classifier 1465 and the generation mechanism 1470 may operate similarly as the classifier 1450 and the generation mechanism 1455 of FIG. 14B, with the generation mechanism 1470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

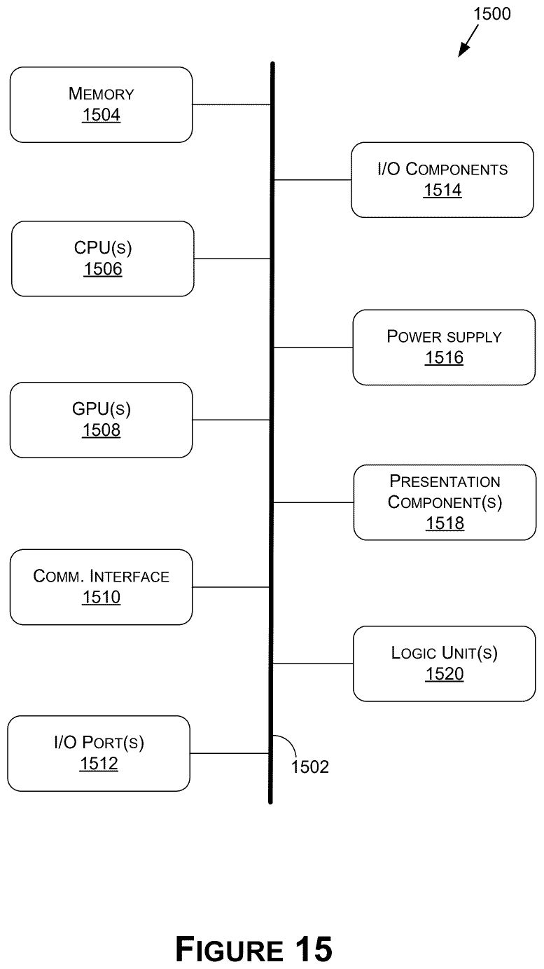

FIG. 15 is a block diagram of an example computing device(s) 1500 suitable for use in implementing some embodiments of the present disclosure. Computing device 1500 may include an interconnect system 1502 that directly or indirectly couples the following devices: memory 1504, one or more central processing units (CPUs) 1506, one or more graphics processing units (GPUs) 1508, a communication interface 1510, input/output (I/O) ports 1512, input/output components 1514, a power supply 1516, one or more presentation components 1518 (e.g., display(s)), and one or more logic units 1520. In at least one embodiment, the computing device(s) 1500 may comprise one or more virtual machines (VMs), and/or any of the components thereof may comprise virtual components (e.g., virtual hardware components). For non-limiting examples, one or more of the GPUs 1508 may comprise one or more vGPUs, one or more of the CPUs 1506 may comprise one or more vCPUs, and/or one or more of the logic units 1520 may comprise one or more virtual logic units. As such, a computing device(s) 1500 may include discrete components (e.g., a full GPU dedicated to the computing device 1500), virtual components (e.g., a portion of a GPU dedicated to the computing device 1500), or a combination thereof.

Although the various blocks of FIG. 15 are shown as connected via the interconnect system 1502 with lines, this is not intended to be limiting and is for clarity only. For example, in some embodiments, a presentation component 1518, such as a display device, may be considered an I/O component 1514 (e.g., if the display is a touch screen). As another example, the CPUs 1506 and/or GPUs 1508 may include memory (e.g., the memory 1504 may be representative of a storage device in addition to the memory of the GPUs 1508, the CPUs 1506, and/or other components). As such, the computing device of FIG. 15 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 15.

The interconnect system 1502 may represent one or more links or busses, such as an address bus, a data bus, a control bus, or a combination thereof. The interconnect system 1502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1506 may be directly connected to the memory 1504. Further, the CPU 1506 may be directly connected to the GPU 1508. Where there is direct, or point-to-point connection between components, the interconnect system 1502 may include a PCIe link to carry out the connection. In these examples, a PCI bus need not be included in the computing device 1500.

The memory 1504 may include any of a variety of computer-readable media. The computer-readable media may be any available media that may be accessed by the computing device 1500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1506 may be configured to execute at least some of the computer-readable instructions to control one or more components of the computing device 1500 to perform one or more of the methods and/or processes described herein. The CPU(s) 1506 may each include one or more cores (e.g., one, two, four, eight, twenty-eight, seventy-two, etc.) that are capable of handling a multitude of software threads simultaneously. The CPU(s) 1506 may include any type of processor, and may include different types of processors depending on the type of computing device 1500 implemented (e.g., processors with fewer cores for mobile devices and processors with more cores for servers). For example, depending on the type of computing device 1500, the processor may be an Advanced RISC Machines (ARM) processor implemented using Reduced Instruction Set Computing (RISC) or an x86 processor implemented using Complex Instruction Set Computing (CISC). The computing device 1500 may include one or more CPUs 1506 in addition to one or more microprocessors or supplementary co-processors, such as math co-processors.

In addition to or alternatively from the CPU(s) 1506, the GPU(s) 1508 may be configured to execute at least some of the computer-readable instructions to control one or more components of the computing device 1500 to perform one or more of the methods and/or processes described herein. One or more of the GPU(s) 1508 may be an integrated GPU (e.g., with one or more of the CPU(s) 1506 and/or one or more of the GPU(s) 1508 may be a discrete GPU. In embodiments, one or more of the GPU(s) 1508 may be a coprocessor of one or more of the CPU(s) 1506. The GPU(s) 1508 may be used by the computing device 1500 to render graphics (e.g., 3D graphics) or perform general purpose computations. For example, the GPU(s) 1508 may be used for General-Purpose computing on GPUs (GPGPU). The GPU(s) 1508 may include hundreds or thousands of cores that are capable of handling hundreds or thousands of software threads simultaneously. The GPU(s) 1508 may generate pixel data for output images in response to rendering commands (e.g., rendering commands from the CPU(s) 1506 received via a host interface). The GPU(s) 1508 may include graphics memory, such as display memory, for storing pixel data or any other suitable data, such as GPGPU data. The display memory may be included as part of the memory 1504. The GPU(s) 1508 may include two or more GPUs operating in parallel (e.g., via a link). The link may directly connect the GPUs (e.g., using NVLINK) or may connect the GPUs through a switch (e.g., using NVSwitch). When combined together, each GPU 1508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1506 and/or the GPU(s) 1508, the logic unit(s) 1520 may be configured to execute at least some of the computer-readable instructions to control one or more components of the computing device 1500 to perform one or more of the methods and/or processes described herein. In embodiments, the CPU(s) 1506, the GPU(s) 1508, and/or the logic unit(s) 1520 may discretely or jointly perform any combination of the methods, processes and/or portions thereof. One or more of the logic units 1520 may be part of and/or integrated in one or more of the CPU(s) 1506 and/or the GPU(s) 1508 and/or one or more of the logic units 1520 may be discrete components or otherwise external to the CPU(s) 1506 and/or the GPU(s) 1508. In embodiments, one or more of the logic units 1520 may be a coprocessor of one or more of the CPU(s) 1506 and/or one or more of the GPU(s) 1508.

Examples of the logic unit(s) 1520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1510 may include one or more receivers, transmitters, and/or transceivers that allow the computing device 1500 to communicate with other computing devices via an electronic communication network, included wired and/or wireless communications. The communication interface 1510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1520 and/or communication interface 1510 may include one or more data processing units (DPUs) to transmit data received over a network and/or through interconnect system 1502 directly to (e.g., a memory of) one or more GPU(s) 1508.

The I/O ports 1512 may allow the computing device 1500 to be logically coupled to other devices including the I/O components 1514, the presentation component(s) 1518, and/or other components, some of which may be built in to (e.g., integrated in) the computing device 1500. Illustrative I/O components 1514 include a microphone, mouse, keyboard, joystick, game pad, game controller, satellite dish, scanner, printer, wireless device, etc. The I/O components 1514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1500. The computing device 1500 may be include depth cameras, such as stereoscopic camera systems, infrared camera systems, RGB camera systems, touchscreen technology, and combinations of these, for gesture detection and recognition. Additionally, the computing device 1500 may include accelerometers or gyroscopes (e.g., as part of an inertia measurement unit (IMU)) that allow detection of motion. In some examples, the output of the accelerometers or gyroscopes may be used by the computing device 1500 to render immersive augmented reality or virtual reality.

The power supply 1516 may include a hard-wired power supply, a battery power supply, or a combination thereof. The power supply 1516 may provide power to the computing device 1500 to allow the components of the computing device 1500 to operate.

The presentation component(s) 1518 may include a display (e.g., a monitor, a touch screen, a television screen, a heads-up-display (HUD), other display types, or a combination thereof), speakers, and/or other presentation components. The presentation component(s) 1518 may receive data from other components (e.g., the GPU(s) 1508, the CPU(s) 1506, DPUs, etc.), and output the data (e.g., as an image, video, sound, etc.).

### Example Data Center

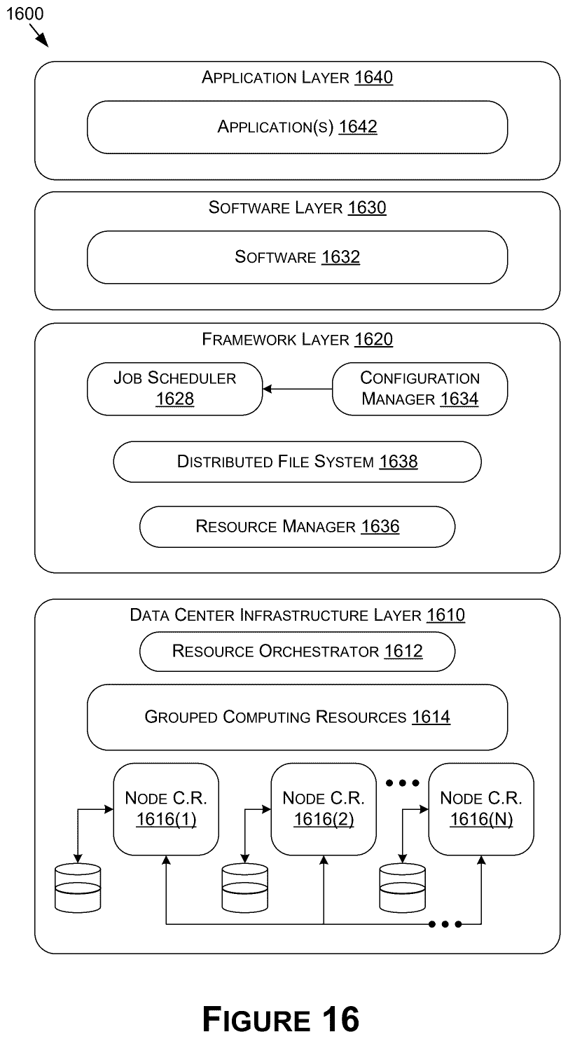

FIG. 16 illustrates an example data center 1600 that may be used in at least one embodiments of the present disclosure. The data center 1600 may include a data center infrastructure layer 1610, a framework layer 1620, a software layer 1630, and/or an application layer 1640.

As shown in FIG. 16, the data center infrastructure layer 1610 may include a resource orchestrator 1612, grouped computing resources 1614, and node computing resources (“node C.R.s”) 1616(1)-1616(N), where “N” represents any whole, positive integer. In at least one embodiment, node C.R.s 1616(1)-1616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1616(1)-1616(N) may correspond to a server having one or more of the above-mentioned computing resources. In addition, in some embodiments, the node C.R.s 1616(1)-16161(N) may include one or more virtual components, such as vGPUs, vCPUs, and/or the like, and/or one or more of the node C.R.s 1616(1)-1616(N) may correspond to a virtual machine (VM).

In at least one embodiment, grouped computing resources 1614 may include separate groupings of node C.R.s 1616 housed within one or more racks (not shown), or many racks housed in data centers at various geographical locations (also not shown). Separate groupings of node C.R.s 1616 within grouped computing resources 1614 may include grouped compute, network, memory or storage resources that may be configured or allocated to support one or more workloads. In at least one embodiment, several node C.R.s 1616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1612 may configure or otherwise control one or more node C.R.s 1616(1)-1616(N) and/or grouped computing resources 1614. In at least one embodiment, resource orchestrator 1612 may include a software design infrastructure (SDI) management entity for the data center 1600. The resource orchestrator 1612 may include hardware, software, or some combination thereof.

In at least one embodiment, as shown in FIG. 16, framework layer 1620 may include a job scheduler 1628, a configuration manager 1634, a resource manager 1636, and/or a distributed file system 1638. The framework layer 1620 may include a framework to support software 1632 of software layer 1630 and/or one or more application(s) 1642 of application layer 1640. The software 1632 or application(s) 1642 may respectively include web-based service software or applications, such as those provided by Amazon Web Services, Google Cloud and Microsoft Azure. The framework layer 1620 may be, but is not limited to, a type of free and open-source software web application framework such as Apache Spark™ (hereinafter “Spark”) that may use distributed file system 1638 for large-scale data processing (e.g., “big data”). In at least one embodiment, job scheduler 1628 may include a Spark driver to facilitate scheduling of workloads supported by various layers of data center 1600. The configuration manager 1634 may be capable of configuring different layers such as software layer 1630 and framework layer 1620 including Spark and distributed file system 1638 for supporting large-scale data processing. The resource manager 1636 may be capable of managing clustered or grouped computing resources mapped to or allocated for support of distributed file system 1638 and job scheduler 1628. In at least one embodiment, clustered or grouped computing resources may include grouped computing resource 1614 at data center infrastructure layer 1610. The resource manager 1636 may coordinate with resource orchestrator 1612 to manage these mapped or allocated computing resources.

In at least one embodiment, software 1632 included in software layer 1630 may include software used by at least portions of node C.R.s 1616(1)-1616(N), grouped computing resources 1614, and/or distributed file system 1638 of framework layer 1620. One or more types of software may include, but are not limited to, Internet web page search software, e-mail virus scan software, database software, and streaming video content software.

In at least one embodiment, application(s) 1642 included in application layer 1640 may include one or more types of applications used by at least portions of node C.R.s 1616(1)-1616(N), grouped computing resources 1614, and/or distributed file system 1638 of framework layer 1620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1634, resource manager 1636, and resource orchestrator 1612 may implement any number and type of self-modifying actions based on any amount and type of data acquired in any technically feasible fashion. Self-modifying actions may relieve a data center operator of data center 1600 from making possibly bad configuration decisions and possibly avoiding underutilized and/or poor performing portions of a data center.

The data center 1600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1600. In at least one embodiment, trained or deployed machine learning models corresponding to one or more neural networks may be used to infer or predict information using resources described above with respect to the data center 1600 by using weight parameters calculated through one or more training techniques, such as but not limited to those described herein.

In at least one embodiment, the data center 1600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1500 of FIG. 15—e .g., each device may include similar components, features, and/or functionality of the computing device(s) 1500. In addition, where backend devices (e.g., servers, NAS, etc.) are implemented, the backend devices may be included as part of a data center 1600, an example of which is described in more detail herein with respect to FIG. 16.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1500 described herein with respect to FIG. 15. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining, based at least on one or more language models processing video data representative of one or more frames, one or more descriptions associated with content depicted in the one or more frames; determining, based at least on the one or more the language models processing input data representative of the one or more descriptions, one or more entities associated with the one or more frames and one or more interactions associated with the one or more entities; generating a graph that includes one or more nodes associated with the one or more entities and one or more edges associated with the one or more interactions; and performing one or more operations using the graph.

B: The method of paragraph A, further comprising: determining one or more timestamps associated with the one or more frames; and associating the one or more edges of the graph with the one or more timestamps.

C: The method of either paragraph A or paragraph B, further comprising: determining, based at least on one or more computer-vision models processing the video data, one or more attributes associated with the one or more entities; and associating the one or more nodes of the graph with the one or more attributes.

D: The method of any one of paragraphs A-C, wherein: the one or more entities include at least a first entity and a second entity; the one or more interactions include at least an interaction between the first entity and the second entity; the one or more nodes of the graph include at least a first node associated with the first entity and a second node associated with the second entity; and the one or more edges of the graph include at least an edge between the first node and the second node that is associated with the interaction.

E: The method of any one of paragraphs A-D, further comprising: determining, based at least on the one or more the language models processing second video data representative of one or more second frames, one or more second descriptions associated with the one or more second frames; determining, based at least on the one or more language models processing second input data representative of the one or more second descriptions, one or more second entities associated with the one or more second frames and one or more second interactions associated with the one or more second entities; and updating the graph to include one or more second nodes associated with the one or more second entities and one or more second edges associated with the one or more second interactions.

F: The method of any one of paragraphs A-E, further comprising: generating one or more embeddings associated with the one or more descriptions; and storing, in one or more databases, the one or more embeddings in association with the graph.

G: The method of any one of paragraphs A-F, wherein the one or more language models include at least: one or more vision-language models that process the video data to determine the one or more descriptions; and one or more large language models that process the input data to determine the one or more entities and the one or more interactions.

H: The method of any one of paragraphs A-G, wherein the performing the one or more operations comprises: receiving a query corresponding to information associated with the one or more frames; determining, based at least on the graph, a response associated with the query; and causing an output associated with the response.

I: The method of paragraph H, wherein the determining the response associated with the query comprises: determining, based at least on the one or more language models processing second input data representative of the query, text associated with the query; retrieving, based at least on searching the graph using the text, information associated with the query; and computing, based at least on the one or more language models processing third input data representative of the information, the response associated with the query.

J: A system comprising: one or more processors to: obtain a graph that includes one or more nodes associated with one or more entities and one or more edges associated with one or more interactions between the one or more entities as depicted by one or more videos; receive a query associated with the one or more videos; determine, based at least on at least a portion of the graph, a response associated with the query; and cause an output associated with the response.

K: The system of paragraph J, wherein the determination of the response associated with the query comprises: determining, based at least on one or more language models processing first input data representative of the query, text associated with the query; determining, based on at least a portion of the text, information from the graph that is associated with the query; and determining, based at least on the one or more language models processing second input data representative of the information, the response associated with the query.

L: The system of paragraph K, wherein the determining the information from the graph that is associated with the query comprises: determining that one or more first words from at least the portion of the text correspond to one or more second words associated with at least one of the one or more nodes or the one or more edges; and determining the information using the at least one of the one or more nodes or the one or more edges.

M: The system of any one of paragraphs J-L, wherein the one or more processors are further to: determine one or more limiting terms associated with the query; and identify, based at least on the one or more limiting terms, the portion of the graph, wherein the response is further determined based at least on the portion of the graph.

N: The system of any one of paragraphs J-M, wherein the one or more processors are further to: access one or more databases that include data representing one or more descriptions associated with the one or more videos; and determine, based at least on the query, at least a description from the one or more descriptions that is associated with the query, wherein the response is further determined based at least on the description.

O: The system of paragraph N, wherein the determination of the response associated with the query comprises: determining, based at least on the graph, information associated with the query; applying, to one or more language models, input data representative of the information and the description; and generating, based at least on the one or more language models processing the input data, output data representative of the response associated with the query.

P: The system of paragraph O, wherein the one or more processors are further to: determine one or more timestamps associated with the information, wherein the description that is associated with the query is further determined based at least on one or more timestamps.

Q: The system of any one of paragraphs J-P, wherein the one or more processors are further to: determine, based at least on one or more language models processing video data representative of the one or more videos, one or more descriptions associated with the one or more videos; determine, based at least on the one or more the language models processing input data representative of the one or more descriptions, the one or more entities and the one or more interactions associated with the one or more videos; and generating the graph that includes the one or more nodes associated with the one or more entities and the one or more edges associated with the one or more interactions.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

S: One or more processors comprising: processing circuitry to: generate a response to a query that is associated with one or more videos by processing, using one or more language models, text represented as a graph, wherein the graph includes one or more graph nodes associated with one or more entities represented by the one or more videos, and one or more graph edges associated with one or more interactions between the one or more entities; and cause an output associated with the response.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
determining, based at least on one or more language models processing video data representative of one or more frames, one or more descriptions associated with content depicted in the one or more frames;
determining, based at least on the one or more the language models processing input data representative of the one or more descriptions, one or more entities associated with the one or more frames and one or more interactions associated with the one or more entities;
generating a graph that includes one or more nodes associated with the one or more entities and one or more edges associated with the one or more interactions; and
performing one or more operations using the graph.

2. The method of claim 1, further comprising:
determining one or more timestamps associated with the one or more frames; and
associating the one or more edges of the graph with the one or more timestamps.

3. The method of claim 1, further comprising:
determining, based at least on one or more computer-vision models processing the video data, one or more attributes associated with the one or more entities; and
associating the one or more nodes of the graph with the one or more attributes.

4. The method of claim 1, wherein:
the one or more entities include at least a first entity and a second entity;
the one or more interactions include at least an interaction between the first entity and the second entity;
the one or more nodes of the graph include at least a first node associated with the first entity and a second node associated with the second entity; and
the one or more edges of the graph include at least an edge between the first node and the second node that is associated with the interaction.

5. The method of claim 1, further comprising:
determining, based at least on the one or more the language models processing second video data representative of one or more second frames, one or more second descriptions associated with the one or more second frames;
determining, based at least on the one or more language models processing second input data representative of the one or more second descriptions, one or more second entities associated with the one or more second frames and one or more second interactions associated with the one or more second entities; and
updating the graph to include one or more second nodes associated with the one or more second entities and one or more second edges associated with the one or more second interactions.

6. The method of claim 1, further comprising:
generating one or more embeddings associated with the one or more descriptions; and
storing, in one or more databases, the one or more embeddings in association with the graph.

7. The method of claim 1, wherein the one or more language models include at least:
one or more vision-language models that process the video data to determine the one or more descriptions; and
one or more large language models that process the input data to determine the one or more entities and the one or more interactions.

8. The method of claim 1, wherein the performing the one or more operations comprises:
receiving a query corresponding to information associated with the one or more frames;
determining, based at least on the graph, a response associated with the query; and
causing an output associated with the response.

9. The method of claim 8, wherein the determining the response associated with the query comprises:
determining, based at least on the one or more language models processing second input data representative of the query, text associated with the query;
retrieving, based at least on searching the graph using the text, information associated with the query; and
computing, based at least on the one or more language models processing third input data representative of the information, the response associated with the query.

10. A system comprising:
one or more processors to:
obtain a graph that includes one or more nodes associated with one or more entities and one or more edges associated with one or more interactions between the one or more entities as depicted by one or more videos;
receive a query associated with the one or more videos;
determine, based at least on at least a portion of the graph, a response associated with the query; and
cause an output associated with the response.

11. The system of claim 10, wherein the determination of the response associated with the query comprises:
determining, based at least on one or more language models processing first input data representative of the query, text associated with the query;
determining, based on at least a portion of the text, information from the graph that is associated with the query; and
determining, based at least on the one or more language models processing second input data representative of the information, the response associated with the query.

12. The system of claim 11, wherein the determining the information from the graph that is associated with the query comprises:
determining that one or more first words from at least the portion of the text correspond to one or more second words associated with at least one of the one or more nodes or the one or more edges; and
determining the information using the at least one of the one or more nodes or the one or more edges.

13. The system of claim 10, wherein the one or more processors are further to:
determine one or more limiting terms associated with the query; and
identify, based at least on the one or more limiting terms, the portion of the graph,
wherein the response is further determined based at least on the portion of the graph.

14. The system of claim 10, wherein the one or more processors are further to:
access one or more databases that include data representing one or more descriptions associated with the one or more videos; and
determine, based at least on the query, at least a description from the one or more descriptions that is associated with the query,
wherein the response is further determined based at least on the description.

15. The system of claim 14, wherein the determination of the response associated with the query comprises:
determining, based at least on the graph, information associated with the query;
applying, to one or more language models, input data representative of the information and the description; and
generating, based at least on the one or more language models processing the input data, output data representative of the response associated with the query.

16. The system of claim 15, wherein the one or more processors are further to:
determine one or more timestamps associated with the information,
wherein the description that is associated with the query is further determined based at least on one or more timestamps.

17. The system of claim 10, wherein the one or more processors are further to:
determine, based at least on one or more language models processing video data representative of the one or more videos, one or more descriptions associated with the one or more videos;
determine, based at least on the one or more the language models processing input data representative of the one or more descriptions, the one or more entities and the one or more interactions associated with the one or more videos; and
generating the graph that includes the one or more nodes associated with the one or more entities and the one or more edges associated with the one or more interactions.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to:
generate a response to a query that is associated with one or more videos by processing, using one or more language models, text represented as a graph, wherein the graph includes one or more graph nodes associated with one or more entities represented by the one or more videos, and one or more graph edges associated with one or more interactions between the one or more entities; and
cause an output associated with the response.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
